(19) United States
(12) Patent Application Publication
(10) Pub. No.: US 2008/0038647 A1
(43) Pub. Date: Feb. 14, 2008

(54) Liquid Developer, Method of Making Liquid Developer, Image Forming Method, and Image Forming Apparatus

(75) Inventors: Takashi TESHIMA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/835,983

(22) Filed: Aug. 8, 2007

(30) Foreign Application Priority Data
Aug. 9, 2006 (JP) 2006-217479

(51) Int. Cl. G03C 5/00; G03G 13/04; G03G 15/20; G03G 9/00

(52) U.S. Cl. 430/48; 399/328; 430/115; 430/137.22

(57) ABSTRACT

A liquid developer includes an insulating liquid and toner particles dispersed in the insulating liquid. The toner particles include a plurality of corpuscle combiners including a resin material, and the insulating liquid includes glyceride of an unsaturated fatty acid.

### BACKGROUND

1. Technical Field

The present invention relates to a liquid developer, a method of making the liquid developer, an image forming method and an image forming apparatus.

2. Related Art

For a developer used to develop an electrostatic latent image formed on a latent image carrier, there are a dry toner method using a toner, which is made of a material containing a coloring agent, such as a pigment, and a binder resin, in a dry condition, and a method using a liquid developer obtained by dispersing a toner in insulating liquid (for example, see JP-A-7-152256).

The dry toner method has an advantage in that it deals with a toner in solid, however, has a problem of an adverse effect of toner powder on a human body and so on, uncleanness caused by scattering of a toner, irregular dispersion of a toner, etc. In addition, this dry toner method has difficulty in forming an toner image having high resolution since particles of the dry toner are apt to be conglomerated, thereby making it difficult to sufficiently decrease size of toner particles. In addition, although the toner particles are formed to be relatively small in size, the above problem of adverse effect of toner powder still remains.

On the other hand, in the method using the liquid developer, since toner particles in the liquid developer are effectively prevented from being conglomerated, it is possible to use fine toner particles and use a binder resin having a low softening point (low softening temperature). As a result, the liquid developer method has a merit of good reproducibility of a thin-line image, good reproducibility of gray scales, excellent color reproducibility and high speed image formation.

However, since the insulating liquid used in such a liquid developer method consists mainly of petrolic hydrocarbon, it may have an adverse effect on environments if it is exuded out of an image forming apparatus.

If a granularity distribution of the toner particles used in the liquid developer is narrow, it is commonly considered that an image attached on a recording medium after fixation has high resolution and concentration. In addition, when the liquid developer is discharged from a developer container to a coating roller, since a number of porosities can be formed between the toner particles due to regularity of the toner particles and there exist a large quantity of insulating liquid between the toner particles, it is possible to efficiently develop and transfer a toner image.

However, typically, in forming an image using the liquid developer, the insulating liquid is adhered to surfaces of the toner particles during a fixing process, which results in deterioration of fixing strength. On this account, in a case where insulating liquid of nonvolatile petrolic mineral such as hydrocarbon or silicon, if toner particles having a narrow granularity distribution are used, a relatively large quantity of insulating liquid is adhered to the toner particles, which results in significant deterioration of fixing strength.

On the other hand, if toner particles having a wide granularity distribution are used, it is possible to suppress deterioration of fixing strength. The toner particles having the narrow granularity distribution include a number of particles having diameter smaller than an average diameter of the toner particles. On this account, when the toner particles having the narrow granularity distribution are used for a liquid developer, since small toner particles are inserted in porosities between large toner particles in a toner image on a recording medium, thereby making porosities between toner particles small, only a small quantity of insulating liquid is adhered to the toner particles. As a result, the amount of insulating liquid adhered to the toner particles on the recording medium becomes small, thereby making it difficult to deteriorate the fixing strength. However, since only the small quantity of insulating liquid is adhered to the toner particles even during developing and transferring processes, efficiency of development and transfer of a toner image are poor and it is difficult to form a toner image having high resolution and concentration. In addition, in repetitive use, since there occurs the so-called selective development in which toner is sequentially developed starting from toner particles having appropriate diameter, there arises a problem of temporal deterioration of performance of a developer.

### SUMMARY

An advantage of some aspects of the invention is to provide a liquid developer which is environmental-friendly and has high fixing strength for a formed toner image and good transferability and development ability, a method of making the liquid developer, an image forming method using the liquid developer, and an image forming apparatus.

According to an aspect of the invention, there is provided a liquid developer including an insulating liquid and toner particles dispersed in the insulating liquid. The toner particles include a plurality of corpuscle combiners including a resin material, and the insulating liquid includes glyceride of an unsaturated fatty acid.

With this configuration, it is possible to provide a liquid developer which is environmental-friendly and is excellent in strength of fixation of a formed toner image and transferability and development ability.

Preferably, viscosity of the insulating liquid is 5 to 1000 mPa·s.

With this configuration, since the appropriate amount of insulating liquid can be supplied to the recording medium in a fixing process, it is possible to obtain a clear toner image with excellent fixation of toner particles onto the recording medium.

Preferably, an iodine value of the insulating liquid is 100 to 200.

With this configuration, it is possible to greatly increase strength of fixation of toner particles onto the recording medium.

Preferably, the content ratio of linoleic acid to total fatty acid components constituting the glyceride is more than 15 mol %.

With this configuration, it is possible to obtain a clear toner image with increased strength of fixation of toner particles onto the recording medium and excellent preservation of the liquid developer.

Preferably, an average diameter of the toner particles is 0.7 to 3 μm.

With this configuration, it is possible to provide toner particles having a very narrow granularity distribution, thereby forming a clear image with very high resolution.

Preferably, an average diameter of corpuscles constituting the toner particles is 0.03 to 1.5 μm.

With this configuration, it is possible to form a clear image with very high resolution.

According to another aspect of the invention, there is provided a method of manufacturing a liquid developer including an insulating liquid and toner particles dispersed in the insulating liquid, including: combining a plurality of corpuscles including a resin material as a main component to obtain corpuscle combiners; and dispersing the corpuscle combiners in a liquid including glyceride of an unsaturated fatty acid.

With this configuration, it is possible to provide a method of manufacturing a liquid developer which is environmental-friendly and is excellent in strength of fixation of a formed toner image and transferability and development ability.

Preferably, the corpuscle combiners are manufactured by: pulverizing a dispersion solution in which dispersoids including the resin material are microscopically dispersed, and discharging the pulverized dispersion solution from a head unit; and removing a dispersion medium from the dispersion solution and obtaining the corpuscle combiners in which the plurality of corpuscles derived from the dispersoids are combined.

With this configuration, it is possible to provide a method of manufacturing a liquid developer which has a very narrow granularity distribution of toner particles and is excellent in fixation strength and resolution of a formed toner image and transferability and development ability.

Preferably, the corpuscle combiners are manufactured by: mixing a resin dispersion solution in which a resin material prepared by emulsified polymerization is microscopically dispersed and a coloring agent dispersion solution in which a coloring agent is microscopically dispersed; and conglomerating dispersoids in the resin dispersion solution and dispersoids in the coloring agent dispersion solution.

With this configuration, it is possible to provide a method of manufacturing a liquid developer with excellent high speed print aptitude.

According to still another aspect of the invention, there is provided an image forming method for fixing toner particles onto a recording medium to which the toner particles are adhered while heating and pressurizing the recording medium, wherein the image forming method uses the liquid developer according to the aspect of the invention.

With this configuration, it is possible to provide an image forming method for obtaining a toner image which is environmental-friendly and is excellent in strength of fixation of a toner image and transferability and development ability of the liquid developer.

Preferably, a toner image is irradiated with an ultraviolet ray when the toner particles are fixed onto the recording medium.

With this configuration, it is possible to provide an image forming method for obtaining a toner image which is excellent in fixation speed and strength.

According to still another aspect of the invention, there is provided an image forming apparatus for fixing toner particles onto a recording medium to which the toner particles are adhered while heating and pressurizing the recording medium, wherein the image forming apparatus uses the liquid developer according to the aspect of the invention.

With this configuration, it is possible to provide an image forming apparatus for obtaining a toner image which is environmental-friendly and is excellent in strength of fixation of a toner image and transferability and development ability of the liquid developer.

Preferably, the image forming apparatus includes an ultraviolet ray irradiation unit that irradiates a toner image with an ultraviolet ray when the toner particles are fixed onto the recording medium.

With this configuration, it is possible to provide an image forming apparatus for obtaining a toner image which is excellent in fixation speed and strength.

### BRIEF DESCRIPTION OF THE DRAWINGS

The invention will be described with reference to the accompanying drawings, wherein like numbers reference like elements.

FIG. 1 is a longitudinal sectional view of a corpuscle combiner manufacturing apparatus (toner particle manufacturing apparatus) used for manufacture of a liquid developer according to an exemplary embodiment of the invention.

FIG. 2 is an enlarged sectional view of the vicinity of a head unit of the corpuscle combiner manufacturing apparatus shown in FIG. 1.

FIG. 3 is a sectional view showing an example of a contact type image forming apparatus according to an example of the invention.

FIG. 4 is a sectional view showing an example of a fixing unit included in an image forming apparatus according to an example of the invention.

FIG. 5 is a sectional view showing an example of a non-contact type image forming apparatus according to an example of the invention.

FIG. 6 is a schematic view showing another example of a structure of the vicinity of the head unit of the particle combiner manufacturing apparatus.

FIG. 7 is a schematic view showing still another example of a structure of the vicinity of the head unit of the particle combiner manufacturing apparatus.

FIG. 8 is a schematic view showing still another example of a structure of the vicinity of the head unit of the particle combiner manufacturing apparatus.

FIG. 9 is a schematic view showing still another example of a structure of the vicinity of the head unit of the particle combiner manufacturing apparatus.

### DESCRIPTION OF EXEMPLARY EMBODIMENTS

Hereinafter, exemplary embodiments of the invention will be described in detail.

### Liquid Developer

To begin with, a liquid developer according to an exemplary embodiment of the invention will be described. The liquid developer is made by dispersing toner particles in insulating liquid.

### Insulating Liquid

Insulating liquid will be described. According to an exemplary embodiment of the invention, the insulating liquid includes unsaturated fatty acid glyceride.

The unsaturated fatty acid glyceride will be described. The unsaturated fatty acid glyceride is ester (glyceride) of a fatty acid and glycerine and includes an unsaturated fatty acid as a fatty acid component.

The unsaturated fatty acid component is a component that contributes to increase in strength of fixation of toner particles onto a recording medium. More specifically, the unsaturated fatty acid component is a component that is cured when oxidized (at a fixation temperature in a fixing process), thereby increasing the fixation strength of the toner particles. This leads to increase in the strength of fixation of toner particles onto the recording medium. In addition, the unsaturated fatty acid glyceride has the effect of plasticizing the toner particles in the fixing process (plasticization effect). When heated and pressurized on the recording medium in the fixing process, the toner particles are effectively plasticized by the unsaturated fatty acid glyceride which is in the vicinity of surfaces of the toner particles. When the plasticized toner particles contact each other and are melted, it is possible to more reliably obtain an image having desired color. In addition, since the unsaturated fatty acid glyceride is environmental-friendly, it is possible to alleviate an adverse effect of the insulating liquid on environments due to leakage of the insulating liquid out of an image forming apparatus, disuse of used liquid developer, etc. As a result, it is possible to provide an environmental-friendly liquid developer. In addition, when the unsaturated fatty acid component is cured, it is possible to easily and reliably make additional recording of a fixed toner image onto an aqueous ball pen.

The unsaturated fatty acid composing the glyceride is not particularly limited and may include univalent unsaturated fatty acids such as crotonic acid, myristoleic acid, palmitoleic acid, oleic acid, elaidic acid, vaccenic acid, gadoleic acid, erucic acid, nervonic acid or the like, unsaturated fatty acids such as linoleic acid, α-linolenic acid, γ-linolenic acid, arachidonic acid, eleostearic acid, stearodonic acid, arachidonic acid, clupanodonic acid, docosahexaenoic acid (DHA), eicosapentaenoic acid (EPA), derivatives thereof, combinations of one or more kinds selected from the above acids, etc.

Among the above acids, when linoleic acid is used as the unsaturated fatty acid, it is possible to significantly increase the strength of fixation of toner particles onto the recording medium. In addition, since linoleic acid has high chemical affinity with toner particles in the fixing process, thereby making it difficult to obstruct melting of toner, it is possible to easily obtain an image having a color of interest. In addition, the high chemical affinity of linoleic acid with toner particles allows the toner particles to be stably dispersed in the insulating liquid, which results in superiority in preservation of the liquid developer.

The content ratio of linoleic acid to overall fatty acid component of unsaturated fatty acid glyceride is not particularly limited, but is preferably more than 15 mol %, more preferably more than 25 mol %, still more preferably more than 45 mol %. If the content ratio of linoleic acid is less than the lower limit, the strength of fixation of toner particles on the recording medium may be deteriorated, which results in inferiority in preservation of the liquid developer.

Such unsaturated fatty acid glyceride may be efficiently obtained from, for example, natural oil including vegetable oil such as safflower oil, rice bran oil, rice oil, rapeseed oil, olive oil, canola oil, soybean oil and the like, and animal oil such as beef tallow and the like.

In this invention, the content of unsaturated fatty acid glyceride in the insulating liquid is preferably 20 to 80 wt %, more preferably 30 to 70 wt %, still more preferably 40 to 60 wt %. If the content of unsaturated fatty acid glyceride is less than the lower limit, it is difficult to raise an oxidative polymerization reaction of unsaturated fatty acid in the fixing process, which may result in decrease of the strength of fixation of toner particles onto the recording medium. On the other hand, if the content of unsaturated fatty acid glyceride is less than the upper limit, it may raise an excessive oxidative polymerization reaction of lots of unsaturated fatty acid in the fixing process, thereby causing solidification in the vicinity of toner particles. This prevents toner particles from being melted in fixation of toner particles onto the recording medium depending on the kind of unsaturated fatty acid component, thereby making it difficult to obtain an image having a desired color.

In addition, a saturated fatty acid component may be included in the unsaturated fatty acid glyceride. The included saturated fatty acid component makes it possible to maintain higher chemical stability of the liquid developer and higher electrical insulation of the insulating liquid.

The saturated fatty acid component may include, for example, butyric acid (C4), caproic acid (C6), caprylic acid (C8), capric acid (C10), lauric acid (C12), mystyric acid (C14), palmitic acid (C16), stearic acid (C18), arachic acid (C20) behenic acid (C22), lignoceric acid (C24), combinations of one or more kinds selected from the above acids, and the like. The number of carbons in the saturated fatty acid component is preferably 6 to 22, more preferably 8 to 20, still more preferably 10 to 18. The saturated fatty acid component included in the unsaturated fatty acid glyceride makes the above-mentioned effects more remarkable.

In addition, fatty acid monoester may be included in the insulating liquid. The fatty acid monoester is ester of fatty acid and univalent alcohol.

Since the fatty acid monoester is apt to penetrate into the recording medium, the fatty acid monoester adhered to the vicinity of surfaces of the toner particles rapidly penetrates into the recording medium when the toner particles contact the recording medium in the faxing process. In addition, while the fatty acid monoester penetrates into the recording medium, some of the toner particles (specifically, resin composing the toner particles) melted by heat generated in the fixing process penetrates into the recording medium, thereby causing an anchor effect for further improvement of fixation strength. Moreover, while the fatty acid monoester penetrates into the recording medium, some of the unsaturated fatty acid glyceride presented in the vicinity of surfaces of the toner particles penetrates into the recording medium, thereby causing an oxidative polymerization reaction to more strongly fix the toner particles onto the recording medium. The fatty acid monoester has the same plasticization effect as the unsaturated fatty acid glyceride. Since the fatty acid monoester has molecule weight smaller than that of the unsaturated fatty acid glyceride, the fatty acid monoester is apt to penetrate between the toner particles, thereby giving a higher plasticization effect. On this account, when the fatty acid monoester exists in the insulating liquid, it is possible to more reliably obtain an image having a desired color. In addition, since the fatty acid monoester is environmental-friendly, it is possible to alleviate an adverse effect of the insulating liquid on environments due to leakage of the insulating liquid out of an image forming apparatus, disuse of used liquid developer, etc. As a result, it is possible to provide an environmental-friendly liquid developer.

The content ratio of fatty acid monoester in the insulating liquid is preferably 5 to 55 wt %, more preferably 10 to 50 wt %, still more preferably 20 to 5 wt %. If the content ratio of fatty acid monoester is within the above range, the fatty acid monoester is apt to adhere to the toner particles, and it becomes possible to properly penetrate the insulating liquid into the recording medium, thereby obtaining increased fixation strength. In addition, the amount of fatty acid monoester sufficient to plasticize the toner particles is adhered to the surfaces of the toner particles, thereby more reliably obtaining an image having a desired color.

On the contrary, if the content ratio of fatty acid monoester is less than the lower limit, the effect of penetration of the insulating liquid into the recording medium and the plasticization effect for the toner particles may not be sufficiently obtained even in the presence of fatty acid monoester. On the other hand, if the content ratio of fatty acid monoester exceeds the upper limit, viscosity of the insulating liquid becomes low, and accordingly, the amount of insulating liquid in which the toner particles of an image formed on the recording medium are dispersed becomes small, thereby making it difficult to obtain a sufficient fixation strength. In addition, for preservation, the fatty acid monoester penetrates between the toner particles to plasticize the toner particles, which may result in deterioration of preservation.

The fatty acid monoester useful for the liquid developer of the invention is not particularly limited, and may include, for example, alkyl (methyl, ethyl, propyl, butyl, etc.) monoester of unsaturated fatty acid, such as oleic acid, palmitoleic acid, linoleic acid, α-linolenic acid, γ-linolenic acid, arachidonic acid, docosahexaenoic acid (DHA), eicosapentaenoic acid (EPA), and the like, alkyl (methyl, ethyl, propyl, butyl, etc.) monoester of saturated fatty acid, such as butyric acid, caproic acid, caprylic acid, capric acid, lauric acid, mystyric acid, palmitic acid, stearic acid, arachic acid, behenic acid, lignoceric acid, and the like, combinations of one or more kinds selected from the above acids, and the like.

In addition, it is preferable that unsaturated fatty acid monoester having an unsaturated fatty acid component added to a fatty acid component is used as the fatty acid monoester. The unsaturated fatty acid component is a component that can contribute to improvement of fixation of the toner particles onto the recording medium. More specifically, the unsaturated fatty acid monoester is oxidative-polymerized and cured in the fixing process, thereby significantly increasing the strength of fixation of the toner particles onto the recording medium. Accordingly, since the unsaturated fatty acid monoester as well as the unsaturated fatty acid glyceride penetrating into the recording medium can contribute to the oxidative polymerization reaction, the above-mentioned anchor effect can be more remarkable, thereby obtaining more increased fixation strength.

In addition, a fatty acid component of the fatty acid monoester is preferably unsaturated fatty acid, but may partially include saturated fatty acid. This provides excellent preservation of the insulating liquid and higher long-term stability of the liquid developer.

The insulating liquid may include other components in addition to the above-described components. For example, the insulating liquid may include mineral oil such as IsoparE, IsoparG, IsoparH, and IsoparL (trade marks owned by Exxon Chemical Company), Sell sole70 and Shell sole71 (trade marks owned by Shell Oil Company), AmscoOMS and Amsco460 solvent (trade marks owned by Spirit Company), low viscosity·high viscosity liquid paraffin (available from Wako Pure Chemical Industries, Ltd.), and the like, saturated fatty acid glyceride, fatty acid ester such as medium-chain fatty acid ester, hydrolysate of fatty acid glyceride such as glycerine, fatty acid and the like, octane, isooctane, decane, isodecane, decalin, nonane, dodecane, isododecane, cyclohexane, cyclooctane, cyclodecane, benzene, toluene, xylene, mesitylene, combinations of one or more kinds of the above components, and the like.

In addition, an antioxidant to prevent oxidation of the unsaturated fatty acid component may be included in the liquid developer (insulating liquid). This can prevent the unsaturated fatty acid component included in the liquid developer from being oxidized unintentionally. As a result, the liquid developer (insulating liquid) can be prevented from being deteriorated with time, and accordingly, dispersibility of the toner particles and the strength of fixation of the toner particles onto the recording medium can remain highly excellent for a long time. In other words, long-term stability (preservation) of the liquid developer is highly excellent.

The above-mentioned antioxidant may include, for example, vitamin E such as tocopherol, d-tocopherol, dl-α-tocopherol, acetic acid-α-tocopherol, acetic acid dl-α-tocopherol, acetic acid tocopherol, α-tocopherol, and the like, vitamin C such as dibuthylhydroxytoluene, buthylhydroxyanisole, ascorbic acid, ascorbic acid salt, ascorbic acid stearic acid ester, and the like, green tea extracts, green coffee extracts, sesamol, sesaminol, combinations of one or more kinds of the above materials.

Among the above materials, vitamin E gives the following effects. Since vitamin E is environmental-friendly and its oxidized substance has little effect on the liquid developer, it is possible to make the liquid developer more environmental-friendly. In addition, since vitamin E has high dispersibility in the liquid (specially, glyceride) including the unsaturated fatty acid component and the saturated fatty acid component as described above, vitamin E is adapted to be used as the antioxidant. In addition, combination of vitamin E and the above-mentioned glyceride can further increase chemical affinity of the insulating liquid with the toner particles. As a result, the preservation of the liquid developer and the strength of fixation of the toner particles onto the recording medium become highly excellent.

In addition, among the above materials, vitamin C gives the following effects. Similarly to the above-mentioned vitamin E, since vitamin C is environmental-friendly and its oxidized substance has little effect on the liquid developer, it is possible to make the liquid developer more environmental-friendly. In addition, since vitamin C has low thermal decomposition temperature, vitamin C functions as the antioxidant sufficiently well for preservation of the liquid developer (including idling of an image forming apparatus), and its capability as the antioxidant is lowered in the fixing process, thereby promoting an oxidative polymerization reaction of the unsaturated fatty acid component.

The thermal decomposition temperature of the antioxidant is preferably less than fixation temperature in the fixing process. This effectively prevents the insulating liquid from being deteriorated in preservation of the liquid developer, and thermally decomposes the antioxidant included in the insulating liquid adhered to the surfaces of the toner particles in the fixing process so that the unsaturated fatty acid component can be effectively cured (oxidative-polymerized), thereby sufficiently increasing the strength of fixation of the toner particles onto the recording medium.

The thermal decomposition temperature of the antioxidant is preferably less than 200° C., more preferably less than 180° C. This can more effectively increase the fixation strength of the toner particles while maintaining the function of the antioxidant well.

The content of the antioxidant in the insulating liquid is preferably 0.01 to 15 wt %, more preferably 0.1 to 7 wt %, still more preferably 1 to 7 wt % for the insulating liquid of 100 wt %. This ensures preventing the unsaturated fatty acid component from being deteriorated due to its oxidation in preservation of the liquid developer, and can progress efficient curing (oxidative polymerization reaction) of the unsaturated fatty acid component if necessary (for example, in the fixing process).

In addition, an oxidative polymerization accelerator (curing accelerator) to accelerate the oxidative polymerization reaction (curing reaction) of the above-mentioned unsaturated fatty acid may be included in the liquid developer. This can effectively oxidative-polymerize (cure) the unsaturated fatty acid component if necessary (for example, in the fixing process). As a result, the strength of fixation of the toner particles onto the recording medium can remarkably increase.

When the oxidative polymerization accelerator is included in the liquid developer, it is preferable but not necessary that the oxidative polymerization accelerator does not substantially contribute to the oxidative polymerization reaction of the unsaturated fatty acid component in preservation of the liquid developer (including idling of an image forming apparatus), but contributes to the oxidative polymerization (curing) reaction of the unsaturated fatty acid component if necessary (for example, in the fixing process). This can provide excellent preservation (long-term stability) of the liquid developer and significantly increased strength of fixation of the toner particles onto the recording medium.

As such an oxidative polymerization accelerator, there may be used a material which accelerates the oxidative polymerization reaction (curing reaction) of the unsaturated fatty acid component when the material is heated, but does not substantially accelerate the oxidative polymerization reaction (curing reaction) of the unsaturated fatty acid component at the room temperature or so, that is, a material having relatively high activation energy for the oxidative polymerization reaction (curing reaction) of the unsaturated fatty acid component.

Such a material (oxidative polymerization accelerator) may include, for example, various kinds of fatty acid metal salts, combinations of one or more kinds of fatty acid metal salts, and the like. Such a material (oxidative polymerization accelerator) can effectively progress the oxidative polymerization reaction (curing reaction) of the unsaturated fatty acid component in the fixing process while maintaining the stability of the liquid developer in preservation of the liquid developer. In particular, since the fatty acid metal salts can accelerate the oxidative polymerization reaction of the unsaturated fatty acid component by supplying oxygen in the fixing process, the fatty acid metal salts can effectively accelerate the oxidative polymerization reaction when the liquid developer is heated in the fixing process. Accordingly, it is possible to more effectively accelerate the oxidative polymerization reaction in the fixing process while more reliably preventing the oxidative polymerization reaction from being raised in preservation of the liquid developer in addition, since the fatty acid metal salts has high dispersibility in the liquid (specially, glyceride) including the unsaturated fatty acid component and the saturated fatty acid component as described above, the fatty acid metal salts can be uniformly dispersed in the insulating liquid, which may result in overall efficient oxidative polymerization reaction in the fixing process.

Such a fatty acid metal salt may include, for example, resin acid metal salt (for example, cobalt salt, manganese salt, lead salt, etc.), linoleic acid metal salt (for example, cobalt salt, manganese salt, lead salt, etc.), octyl acid metal salt (for example, cobalt salt, manganese salt, lead salt, zinc salt, calcium salt, etc.), naphthenic acid metal salt (for example, zinc salt, calcium salt, etc.), combinations of one or more kinds of the above salts, and the like.

In addition, the oxidative polymerization accelerator may be capsulated and included in the insulating liquid. Similar to the above, this allows the oxidative polymerization accelerator not to substantially contribute to the oxidative polymerization reaction of the unsaturated fatty acid component in preservation of the liquid developer (including idling of an image forming apparatus), but to contribute to the oxidative polymerization (curing) reaction of the unsaturated fatty acid component if necessary. That is, it is possible to more reliably prevent the oxidative polymerization reaction in preservation of the liquid developer while reliably progressing the oxidative polymerization reaction of the unsaturated fatty acid component when the oxidative polymerization accelerator contacts the unsaturated fatty acid component as an oxidative polymerization accelerator capsule is crushed by pressure in the fixing process. In addition, with this configuration, a range of selection of materials of the oxidative polymerization accelerator is widened. In other words, even a high-reactive oxidative polymerization accelerator (oxidative polymerization accelerator that contributes to the oxidative polymerization reaction of the unsaturated fatty acid component at a relatively low temperature) can be properly used, and the strength of fixation of the toner particles onto the recording medium can significantly increase.

The content of oxidative polymerization accelerator in the insulating liquid is preferably 0.01 to 15 wt %, more preferably 0.05 to 7 wt %, still more preferably 0.1 to 5 wt % for the insulating liquid of 100 wt %. This ensures preventing the oxidative polymerization reaction in preservation of the liquid developer and progressing the oxidative polymerization reaction of the unsaturated fatty acid component in the fixing process.

In this invention, an iodine value of the insulating liquid is preferably 100 to 200, more preferably 100 to 180, still more preferably 110 to 170. This makes it possible to easily obtain an image having a desired color while providing good fixation of the toner particles onto the recording medium. On the contrary, if the iodine value of the insulating liquid is less than the lower limit, it is difficult to raise the oxidative polymerization reaction of the unsaturated fatty acid, which may result in deterioration of the strength of fixation of the toner particles onto the recording medium. On the other hand, if the iodine value of the insulating liquid exceeds the upper limit, it may raise an excessive oxidative polymerization reaction of lots of unsaturated fatty acid, thereby causing solidification in the vicinity of toner particles. This may prevent toner particles from being melted in fixation of the toner particles onto the recording med, thereby making it difficult to obtain an image having a desired color.

Viscosity of the insulating liquid is not particularly limited, but is preferably 5 to 1000 mPa·s, more preferably 50 to 800 mPa·s, still more preferably 100 to 500 mPa·s. If the viscosity of the insulating liquid is within the above range, when the liquid developer is discharged from a developer container to a coating roller, the appropriate amount of insulating liquid is adhered to the toner particles, thereby making transferability and development ability of a toner image excellent. In addition, since the insulating liquid is appropriately adhered to the toner particles on the recording medium, it is possible to significantly increase fixation strength of a formed toner image, obtain excellent gloss by melting of the toner particles due to the plasticization effect, and very easily obtain an image having a desired color. In addition, it is possible to prevent the toner particles from being conglomerated and sunk, thereby making dispersibility higher. On this account, in an image forming apparatus as will be described later, it is possible to uniformly supply the liquid developer to a coating roller and effectively prevent the liquid developer from dripping from the coating roller.

On the contrary, if the viscosity of the insulating liquid is less than the lower limit, when the liquid developer is discharged from the developer container to the coating roller, a small quantity of insulating liquid is adhered to the toner particles, thereby making it difficult to obtain excellent transferability and development ability of a toner image. In addition, since the amount of insulating liquid adhered to the toner particles is small, the oxidative polymerization reaction of the insulating liquid is not sufficiently raised, thereby making it difficult to obtain sufficient fixation strength. In addition, in an image forming apparatus as will be described later, there is a possibility of dripping of the liquid developer from the coating roller.

On the other hand, if the viscosity of the insulating liquid exceeds the upper limit, a large quantity of insulating liquid is adhered to the toner particles on the recording medium, thereby preventing the toner particles from being melted in the fixing process and thus making it difficult to obtain an image having a desired color. In addition, in some cases, dispersibility of the toner particles may not be sufficiently high, and the liquid developer may not be uniformly supplied to the coating roller in an image forming apparatus as will be described later. In this invention, the viscosity indicates a value measured at 25° C.

Electrical resistance of the above-described insulating liquid at a room temperature (20° C.) is preferably more than 1×10⁹ Ωcm, more preferably more than 1×10¹¹ Ωcm, still more preferably more than 1×10¹³ Ωcm.

In addition, a dielectric constant of the insulating liquid is preferably less than 3.5.

### Toner Particle

Next, toner particles will be described.

### Material of Toner Particle

Toner particles (toner) constituting the liquid developer of the invention include at least a binder resin (resin material) and a coloring agent.

### 1. Resin Material

Toner constituting a liquid developer is made of a material including resin as a main component.

In this embodiment, resin (binder resin) is not particularly limited, and may include, for example, monopolymer or copolymer, such as polystyrene, poly-α-methylstyrene, chloropolystyrene, styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-ester acrylate copolymer, styrene-esther metacrylate copolymer, styrene-esther acrylate-esther metacrylate copolymer, styrene-α-methyl chloroacrylate copolymer, styrene-acrylonitrile-esther acrylate copolymer, styrene-vinyl methyl ether copolymer, including styrene or styrene substituent, polyester resin, epoxy resin, urethane modified epoxy resin, silicon modified epoxyresin, vinyl chloride resin, rosin modified maleic resin, phenyl resin, polyethylene resin, polypropylene ionomer resin, polyurethane resin, silicon resin, ketone resin, ethylene-ethylacrylate copolymer, xylene resin, polyvinylbutyral resin, terpene resin, phenol resin, aliphatic or cycloaliphatic hydrocarbon resin, combinations of one or more kinds of the above resins.

Softening temperature of resin (resin material) is not particularly limited, and is preferably 50 to 130° C., more preferably 50 to 120° C., still more preferably 60 to 115° C. In the specification, the softening temperature refers to softening initiation temperature specified in measurement conditions (heating rate: 5° C./min, and die hole diameter: 1.0 mm) in a melt flow tester (available from Shimadzu Corporation).

### 2. Coloring Agent

Toner includes a coloring agent. The coloring agent may include, for example, pigments, dyes, etc. Pigments or dyes used may include, for example, carbon black, spirit black, lamp black (C.I. No.77266), fast yellow, navel orange yellow, naphthol yellow S, Hansa yellow G, permanent yellow NCG, chrome yellow, benzidine yellow, quinoline yellow, tartrazine rake, red chrome yellow, molybdenum orange, permanent orange GTR, pyrazolone orange, benzidine orange G, cadmium--red), permanent red 4R, watching red calcium salt, eosin lake, brilliant carmine 3B, manganese violet, fast violet B, methyl violet lake, prussian blue, cobalt blue, alkali blue lake, victoria blue lake, first skyblue, indanthrene blue BC, ultramarine, aniline blue, phthalocyanine blue, charcoal blue, chrome green, chromium oxide, pigment green B, malachite green lake, phthalocyanine green, final yellow green G, rhodamine 6G, quinacridone, rose Bengal (C. I. No. 45432), C. 1. direct red 1, C. I. direct red 4, C. I. acid red 1, C. I. basic red) 1, C. I. mordant red 30, C. I. pigment red 48:1, C. I. pigment red 57:1, C. I. pigment red 122, C. I. pigment red 184, C. I. direct blue 1, C. I. direct blue 2, C. I. acid blue 9, C. I. acid blue 15, C. I. basic blue 3, C. I. basic blue 5, C. I. mordant blue 7, C. I. pigment blue 15:1, C. I. pigment blue 15:3, C. I. pigment blue 5:1, C. I. direct green 6, C. I. basic green 4, C. I. basic green 6, C. I. pigment yellow 17, C. I. pigment yellow 93, C. I. pigment yellow 97, C. I. pigment yellow 12, C. I. pigment yellow 180, C. I. pigment yellow 162, nigrosine dye (C. I. No.50415 B), metal coloring dye, silica, aluminum oxide, magnetite, maghemite, ferrites, metal oxides such as cupric oxide, nickel oxide, zinc oxide, zirconium oxide, titanium oxide, magnesium oxide, magnetic materials including magnetic metal such as Fe, Co, Ni and the like, combinations of one or more kinds of the above materials.

### 3. Other Components

Toner may include other components in addition to the above mentioned components. Other components may include, for example, wax, charging control agent, magnetic powder, etc.

Wax may include, for example, hydrocarbons wax such as ozokerite, cercine, paraffin wax, micro wax, microcrystalline wax, petrolatum, Fischer-Tropsch wax, and the like, esters wax such as carnauba wax, rice wax, lauric acid methyl, myristic acid, palmitic acid methyl, stearic acid methyl, stearic acid butyl, candelilla wax, cotton low, wood low, honey low, lanolin, montan wax, fatty acid ester, and the like, olefins wax such as polyethylene wax, polypropylene wax, oxidized polyethylene wax, oxidized polypropylene wax, and the like, amides wax such as 12-hydroxy stearic acid amide, stearic acid amide, phthalic anhydride imide, and the like, kentones wax such as Laurone, stearone, and the like, ethers wax, combinations of one or more kinds of the above waxes, and so on.

The charge control agent may include, for example, metal salt of benzoic acid, metal salt of salicylic acid, metal salt alkylsalicylic acid, metal salt of catechol, metal-contained bisazo dyes, nigrosine dye, tetraphenylborate derivative, quaternary ammonium salt, alkylpyridinium salt, chlorinated polyester, nitrohuminic acid, and the like.

The magnetic powder may include, for example, metal oxide such as magnetite, maghemite, ferrites, cupric oxide, nickel oxide, zinc oxide, zirconium oxide, titanium oxide, magnesium oxide, and the like, magnetic materials including Fe, Co, Ni, and the like.

In addition to the above-mentioned materials, the constituent materials (components) of the toner particles may include, for example, zinc stearate, zinc oxide, cerium oxide, silica, titanium oxide, iron oxide, fatty acid, metal salt of fatty acid, and the like.

### Shape of Toner Particle

In this invention, a toner particle consists of a plurality of corpuscles including resin material. The toner particle has microscopic unevenness on its surface due to the plurality of corpuscles. Such microscopic unevenness enables more insulating liquid to be maintained on the particle surface. On this account, when the insulating liquid is discharged from a developer container and is adhered to the coating roller, a large quantity of insulating liquid can be maintained on surfaces of toner particles, thereby enabling more efficient development and transfer.

In addition, since the toner particle has the microscopic unevenness, an area of contact between toner particles on a recording medium increases, thereby facilitating conglomeration of toner particles melted in the fixing process. On this account, it is possible to increase fixation strength of a formed image. In addition, when the toner particle has the microscopic unevenness, a surface area per volume of the toner particle is large and an area of contact of the toner particle surface to the insulating liquid is large. On this account, the insulating liquid having the plasticization effect functions as a plasticizer more effectively in the fixing process, and the toner particles are particularly easily plasticized. In addition, the insulating liquid is oxidative-polymerized in the fixing process. The toner particles are conglomerated and an oxidative polymerization reaction is raised in the fixing process, thereby causing the plasticization effect synergistically. Since the insulating liquid can be maintained on the surfaces of the toner particles due to the microscopic unevenness, the above synergistic plasticization effect can be more reliably obtained, thereby obtaining increased fixation strength.

In addition, since the toner particles are apt to be melted and conglomerated, it is possible to easily obtain an image having a desired color. In addition, for preservation, since a large quantity of insulating liquid can be maintained on the surfaces of the toner particles, it is possible to easily disperse the toner particles in the insulating liquid and provide excellent preservation of the liquid developer including the toner particles.

In addition, since the toner particles have a plurality of corpuscles having diameter smaller than an average diameter of the toner particles, irregularity of characteristics of the toner particles decreases, thereby obtaining toner particles having high reliability. Corpuscles constituting the toner particles are preferably uniform to form toner particles having uniform characteristics and diameter. However, even when there exist some irregularity of diameter and characteristics of the corpuscles, a great number of corpuscles can make irregularity of diameter and characteristics of toner particles small.

If toner particles made by a pulverizing method is not subject to a heat treatment in order to turn the toner particles into a spherical shape, the toner particles are indeterminate and have microscopic unevenness. However, since the toner particles have a wide granularity distribution by a pulverizing process, it is difficult to make the width of the granularity distribution sufficiently narrow even by a classification process. On this account, when the insulating liquid is discharged from a developer container and is adhered to the coating roller, small toner particles are inserted between large toner particles, a space secured for the insulating liquid between the toner particles become small. As a result, insulating liquid for development and transfer becomes insufficient, which results in low efficiency of development and transfer. If the efficiency of development and transfer is low, toner particles remain in a developing roller and a transfer roller, which is likely to cause problems such as bad filming, cleaning and the like. In addition, small toner particles are apt to be conglomerated in the developer container and the conglomerates and large toner particles are apt to be sunk, thereby making it difficult to provide excellent preservation of the liquid developer.

In this invention, an average diameter of the toner particles is preferably 0.7 to 3 μm, more preferably 0.8 to 2.5 μm, still more preferably 0.8 to 2 μm. If the average diameter of the toner particles is within the above range, since the toner particles are constituted by the appropriate number of corpuscles, the width of the granularity distribution of the toner particles becomes very narrow, thereby making irregularity of characteristics of the toner particles small. As a result, it is possible to significantly improve overall reliability of the liquid developer and provide sufficiently high resolution of a toner image formed by the liquid developer.

On the contrary, if the average diameter of the toner particles is less than the lower limit, since the number of corpuscles constituting the toner particles becomes small, the granularity distribution of the toner particles becomes wide, thereby making irregularity of characteristics of the toner particles large. As a result, it is difficult to improve overall reliability of the liquid developer and thus obtain excellent development ability and transferability. On the other hand, if the average diameter of the toner particles exceeds the upper limit, since the average diameter is large although the irregularity of diameter and characteristics of the toner particles becomes small, it is difficult to provide sufficiently high resolution of a formed toner image. In addition, in preservation of the liquid developer, the toner particles are apt to be sunk, thereby making it difficult to provide excellent preservation of the liquid developer. In the specification, “average diameter” refers to an average diameter on the basis of volume.

The average diameter of corpuscles constituting the toner particles made of the above-described materials is preferably 0.03 to 1.5 μm, more preferably 0.1 to 1.3 μm, still more preferably 0.2 to 1.2 μm. If the average diameter of corpuscles is within the above range, the toner particles can be constituted by a large quantity of corpuscles, thereby making irregularity of the diameter and characteristics of the toner particles small. In addition, even when the diameter of the toner particles is small, since the characteristics of the corpuscles are averaged, the irregularity of the diameter and characteristics of the toner particles becomes small. Accordingly, since toner particles having small diameter can be used for the liquid developer, it is possible to provide high resolution of a formed toner image and a liquid developer having high reliability. On the contrary, if the average diameter of corpuscles is less than the lower limit, since the diameter of corpuscles becomes extremely small as compared to the diameter of toner particles, the toner particles have about a real spherical shape, thereby making it difficult to obtain sufficient unevenness for maintenance of the insulating liquid. On the other hand, if the average diameter of corpuscles exceeds the upper limit, since the number of corpuscles constituting the toner particles becomes small, there may occur irregularity of the diameter and characteristics of the toner particles.

Assuming that the average diameter of toner particles is DT and the average diameter of corpuscles is DP, preferably, a relationship of 0.04≦DP/DT≦1.0, more preferably, a relationship of 0.07≦DP/DT≦1.0, still more preferably, a relationship of 1.0.<DP/DT<1.0 is satisfied. When the above relationship is satisfied, the irregularity of the diameter and characteristics of the toner particles becomes small, thereby obtaining microscopic unevenness. If the average diameter of corpuscles is less than the lower limit, the shape of the toner particles approaches to a real spherical shape, thereby making it difficult to obtain microscopic unevenness and thus an effect by the microscopic unevenness. If the average diameter of corpuscles exceeds the upper limit, since the number of corpuscles constituting the toner particles becomes small, there may occur irregularity of the diameter of the toner particles.

In this invention, width S of a granularity distribution of the toner particles, as represented by the following equation (I) is preferably less than 1.4, more preferably less than 1.3, still more preferably less than 1.2,

S=[D(90)−D(10)]/D(50) (I)

where D(X) represents a diameter at a point of X % of total volume as accumulated volume when a granularity distribution of toner particles is measured starting from toner particles having smaller diameter.

If the width S of the granularity distribution of the toner particles is sufficiently small, irregularity of the diameter of the toner particles becomes small, and thus, since porosities between the toner particles becomes large when the liquid developer is discharged from the developer container to the coating roller, the appropriate amount of insulating liquid is adhered to the toner particles, thereby making it possible to provide efficient transfer and development. In addition, in the fixing process, since the appropriate amount of insulating liquid is presented between the toner particles, it is possible to obtain increased fixation strength. In addition, since the irregularity of the diameter of the toner particles is small, pressure and heat are apt to be uniformly applied to the toner particles in the fixing process, thereby melting the toner particles uniformly to obtain an image having a desired color. In addition, since the toner particles are uniformly melted, it is possible to obtain a toner image having high smoothness and thus high gloss.

On the contrary, if the width S of the granularity distribution of the toner particles is more than the upper limit, irregularity of the diameter of the toner particles becomes large, and thus, when the liquid developer is discharged from the developer container to the coating roller, since small toner particles are inserted between large toner particles, and porosities between the toner particles becomes small, the amount of insulating liquid adhered to the toner particles is not sufficient, thereby making it difficult to provide efficient transfer and development. In addition, pressure and heat are not uniformly applied to the toner particles in the fixing process, thereby making it difficult to melt the toner particles uniformly to obtain an image having a desired color. In addition, smoothness of a toner image may be worsened, and thus its gloss becomes low. In addition, with diameter of the toner particles selective, as development is slowly progressed and characteristics of the developer become deteriorated, image quality becomes varied from an initial state.

### Manufacturing Method of Liquid Developer

Next, a manufacturing method of the liquid developer according to an exemplary embodiment of the invention will be described in detail with reference to the accompanying drawings.

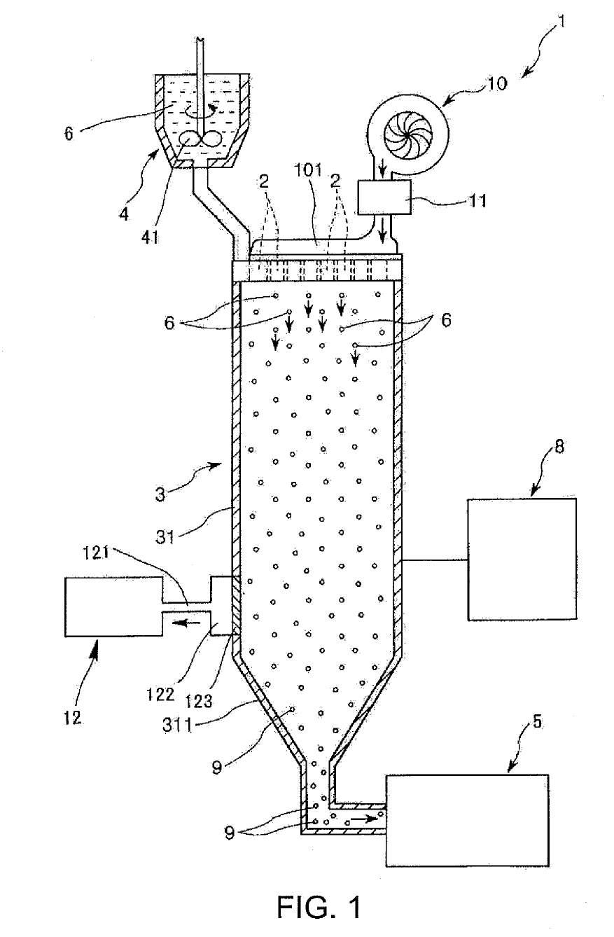

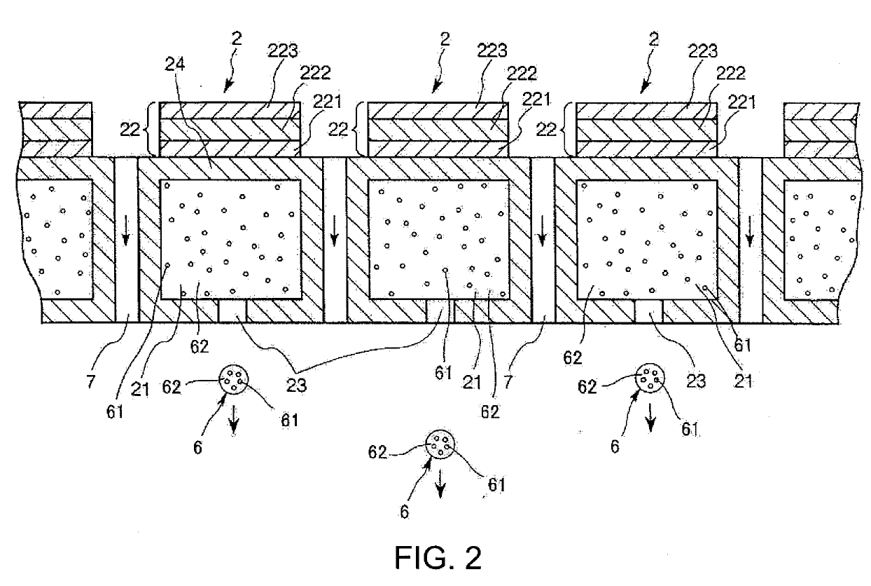

FIG. 1 is a longitudinal sectional view of a corpuscle combiner manufacturing apparatus used for manufacture of the liquid developer according to an exemplary embodiment of the invention, and FIG. 2 is an enlarged sectional view of the vicinity of a head unit of the corpuscle combiner manufacturing apparatus shown in FIG. 1.

Although the liquid developer of this invention may be manufactured using any methods, it is preferable to obtain the liquid developer using a combining process of combining corpuscles including resin material as a main component to obtain a corpuscle combiner and a dispersing process of dispersing the toner particles in liquid including glyceride of the unsaturated fatty acid.

The liquid developer manufacturing method according to this embodiment includes a dispersion liquid preparing step of preparing a dispersion liquid by dispersing dispersoids made of the above-described toner materials in a dispersion medium, a discharging step of discharging the dispersion liquid as corpuscular suspension from a head unit, a dispersion medium removing step (combining step) of removing the dispersion medium and combining the dispersoids to obtain a corpuscle combiner, and a dispersing step of dispersing the corpuscle combiner in the insulating liquid. In this embodiment, a case where an aqueous dispersion liquid (aqueous suspension) obtained by dispersing dispersoids in an aqueous dispersion medium constituted by aqueous liquid is used as the dispersion liquid will be described. When the aqueous dispersion liquid is used, it is possible to provide a liquid developer in an environmental-friendly manner.

Although the aqueous dispersion liquid may be prepared using any methods, it is prepared by using a mixture including a coloring agent and a resin material in this embodiment.

In addition, constituent material (component) of the mixture may include, for example, materials used as solvents such as an inorganic solvent, an organic solvent and the like, in addition to the materials constituting the above-described toner. For example, this can improve mixture efficiency to easily obtain mixtures including various uniformly mixed components.

### Mixture

Next, an example of a method of obtaining a mixture by mixing raw materials including the above-described toner materials will be described.

### Mixture Process

Raw materials for mixture include the above-described toner materials. In particular, when the raw materials include the coloring agent, it is possible to efficiently remove air (particularly, air drawn in by the coloring agent) included in the raw materials in the mixture process, thereby effectively preventing bubbles from mixing (remaining) in toner particles. The raw materials for mixture preferably include the above-described components which are mixed in advance.

Various mixers such as a continuous biaxial mixing extruder, a kneader or batch type triaxial roll, a continuous biaxial roll, a wheel mixer, a blade type mixer and the like may be used for mixture of the raw materials. Among them, it is preferable to use the continuous biaxial mixing extruder. This allows air included in the raw materials to be removed while allowing the raw materials to be efficiently mixed.

Temperature of the raw materials in mixture is preferably 80 to 260° C., more preferably 90 to 230° C. depending on composition of the raw materials. The temperature of the raw materials may be varied depending on portions of the raw materials.

Mixture time of the raw materials is preferably 0.5 to 12 minutes, more preferably 1 to 7 minutes. If the mixture time is less than the lower limit, it may be difficult to mix components of the raw materials sufficiently uniformly. On the other hand, if the mixture time exceeds the upper limit, productivity is lowered, and the raw materials are apt to be deformed due to heat depending on the kind of mixer, temperature of raw material, the number of rotations of a screw and so on, thereby making it difficult to sufficiently control physical property of the liquid developer (toner) finally obtained.

In addition, the raw materials may be mixed using two mixers. In this case, one mixer may be different from the other mixer in terms of heating temperature of the raw materials, the rotation speed of a screw and the like.

### Cooling Process

Softened mixture obtained through the mixture process is cooled and solidified by a cooler. The cooler may include a belt type cooler, a roll type (cooling roll type) cooler, etc. In addition, without using a cooler, the mixture may be cooled by air or the like. Among these cooling methods, the belt type cooler can particularly increase cooling efficiency of the mixture.

In the mean time, since a shear force is applied to the raw materials in the mixture process, phase separation (particularly macro phase separation) can be sufficiently prevented. However, since a shear force is not applied to the mixture after the mixture process any longer, phase separation (particularly macro phase separation) may be caused when the mixture is left alone for a long time, depending on the constituent material of the mixture. On this account, it is preferable to cool the obtained mixture as soon as possible. Time taken from the end of the mixture process (point of time when the shear force is not applied) to the end of the cooling process (for example, time required to cool the mixture below temperature of less than 60° C.) is preferably less than 20 seconds, more preferably 3 to 12 seconds.

### Pulverizing Process

Next, the mixture that was subject to the above cooling process is pulverized. By pulverizing the mixture, it is possible to relatively easily obtain an aqueous emulsified solution in which fine dispersoids are dispersed, which will be described later. As a result, it is possible to further decrease the diameter of the toner particles in the resultant liquid developer, thereby making it possible to form an image having higher resolution.

A pulverizing method is not particularly limited, and may be performed using various pulverizers or crushers such as a ball mill, a vibration mill, a jet mill, a fin mill and the like.

The pulverizing process may be performed plural times (for example, in two steps, that is, a coarse pulverizing step and a fine pulverizing step). After the pulverizing process, a classifying process may be performed if necessary. The classifying process may be performed using, for example, a sieve, an air stream classifier or the like.

As described above, by mixing the raw materials, it is possible to effectively remove air included in the raw materials. In other words, the mixture obtained by the above-described mixture process does not nearly include air (bubbles) therein. This can effectively prevent abnormal particles (hollow particles, deficient particles, fused particles and the like) from being produced in a corpuscle combiner manufacturing process which will be described later. As a result, it is possible to effectively prevent problems such as deterioration of transferability, cleaning and so on due to abnormal toner particles in the resultant liquid developer.

In this embodiment, an aqueous emulsified solution is prepared using the above-described mixture.

When the mixture is used to prepare the aqueous emulsified solution, the following effected are obtained. Even when toner components hardly dispersed or dissolved are included in the toner, the mixture obtained through the mixture process includes components that are sufficiently dissolved and dispersed. Particularly, although a pigment (coloring agent) typically has low dispersibility in liquid used as a solvent, which will be described later, when the pigment is subject to the mixture process in advance before the pigment is dispersed in the solvent, pigment particles are effectively coated with a resin component. This improves the dispersibility of the pigment in the solvent, which results in good color development of the resultant toner. Accordingly, even when the constituent material of the toner includes a component having low dispersibility in a dispersion medium of an aqueous emulsified solution (aqueous dispersion medium) (hereinafter also referred to as “low dispersive component”) and a component having low solubility in a solvent included in the aqueous dispersion medium (hereinafter also referred to as “low soluble component”), it is possible to provide excellent dispersibility of dispersoids in the aqueous emulsified solution and excellent dispersibility of dispersoids 61 in an aqueous suspension 6 prepared using the aqueous emulsified solution. As a result, it is possible to make irregularity of compositions and characteristics of toner particles in the resultant liquid developer small, thereby providing excellent overall characteristics.

On the contrary, if raw materials which is not subject to the mixture process are used to prepare the aqueous emulsified solution, low dispersive components or low soluble components are conglomerated and sunk in the aqueous emulsified solution or an aqueous suspension which will be described later, or dispersoids which mainly include a low dispersive component or a low soluble component and have diameter so relatively large as to be not sufficiently mixed with other components exist in the aqueous emulsified solution (and the aqueous suspension which will be described later) (as dispersoids which have large diameter and mainly include low dispersive components and/or low soluble components are mixed with dispersoids mainly including components other than low dispersive components and low soluble components), irregularity of compositions, size and shape of toner particles in a corpuscle combiner obtained in the corpuscle combiner manufacturing process which will be described later becomes large. As a result, when the corpuscle combiner or its deagglomeration is used as toner particles in the liquid developer, overall characteristics of toner (liquid developer) become deteriorated.

In addition, if pulverizations of the mixture obtained as above are directly used as toner particles without being used to prepare the aqueous emulsified solution, there is a limitation in increasing regularity (dispersibility) of components of the toner. Also, it is particularly difficult for such a method to (microscopically) disperse a pigment which is generally a relatively strong conglomerate (or apt to be a strong conglomerate). On the contrary, when the above-described mixture is used to prepare the aqueous emulsified solution, components of the resultant toner particles can be sufficiently regularly dissolved and (microscopically) dispersed.

In addition, since dispersoids in the aqueous emulsified solution used in this embodiment are liquefied (relatively easily deformable with mobility), the dispersoids tend to have high circularity (sphericity) due to their surface tension. Accordingly, a suspension prepared using the aqueous emulsified solution (aqueous suspension) also has relatively high circularity (sphericity), thereby providing a relatively uniform shape of toner particles. Thus, relatively large porosities in which the insulating liquid can be maintained are produced between corpuscles of the corpuscle combiner obtained by combination of dispersoids. On this account, the insulating liquid is bled out of the toner particles and is solidified while pressure is being applied in the fixing process, thereby providing increased strength of fixation of a toner image onto a recording medium.

In addition, by agitating the emulsified solution in which the dispersoids are liquefied (relatively easily deformable with mobility), it is possible to relatively easily increase regularity of size of the dispersoids sufficiently. On the contrary, if the suspension is used to manufacture the corpuscle combiner, which will be described later, without via the aqueous emulsified solution, dispersoids included in the suspension have small circularity, and, particularly, shape and diameter of particles of the dispersoids become irregular. In addition, in order to suppress the irregularity of the shape, it may be considered to subjecting the corpuscle combiner to a thermal sphericity treatment at the time of forming the corpuscle combiner or before forming the corpuscle combiner. However, in this case (particularly a case where the corpuscle combiner is subject to the thermal sphericity treatment at the time of forming the corpuscle combiner), unless conditions on the thermal sphericity treatment are relatively strict, it is difficult to make irregularity of shape of the obtained corpuscle combiner small sufficiently and obtain sufficient unevenness on a surface of the corpuscle combiner. In addition, it is likely to deteriorate constituent materials of the corpuscle combiner and break the dissolved state and the microscopically dispersed state of the components of the corpuscle combiner, and it is difficult to show characteristics of the resultant liquid developer sufficiently.

### Aqueous Emulsified Solution Preparing Process

Next, using the above described mixture, the aqueous emulsified solution in which the dispersoids made of toner materials are dispersed in the aqueous dispersion medium composed of aqueous liquid is prepared (aqueous emulsified solution preparing process).

A method of preparing the aqueous emulsified solution is not particularly limited. In this embodiment, the aqueous emulsified solution is prepared by obtaining a mixture solution in which at least some of the mixture is dissolved and dispersing the obtained mixture solution in the aqueous dispersion medium. In the specification, “emulsified solution (emulsion)” refers to dispersion liquid in which liquefied dispersoids (dispersion particles) are dispersed in a liquefied dispersion medium, and “suspension” refers to dispersion liquid (including suspended colloid) in which solidified dispersoids (suspension particles) are dispersed in a liquefied dispersion medium. In a case where liquefied dispersoids and solidified dispersoids exist together in dispersion liquid, if the total volume of the liquefied dispersoids is larger than the total volume of the solidified dispersoids in the dispersion liquid, it is assumed to be the emulsified solution, and, on the contrary, if the total volume of the solidified dispersoids is larger than the total volume of the liquefied dispersoids in the dispersion liquid, it is assumed to be the suspension.

Hereinafter, the method of preparing the aqueous emulsified solution will be described in detail.

### Preparation of Mixture Solution

In this embodiment, to begin with, a mixture solution in which at least a portion of the mixture is dissolved is obtained.

The mixture solution can be prepared by mixing the mixture with a solvent which can dissolve at least a portion of the mixture.

The solvent used to prepare the mixture solution is not particularly limited as long as it can dissolve at least a portion of the mixture. It is typically preferable to use a solvent having low solubility with the aqueous liquid which will be described later (aqueous liquid used for preparation of the aqueous emulsified solution). For example, liquid having solubility of less than 10 g with respect to aqueous liquid of 100 g at 25° C. may be used as the solvent.

Such a solvent may include, for example, inorganic solvent such as carbon disulfide, carbon chloride, and the like, organic solvent including ketones solvent such as methylethylketone (MEK), methyl isopropyl ketone (MIPK), 2-heptanone, and the like, alcohols solvent such as pentanol, n-hexanol, 1-octanol, 2-octanol, and the like, ethers solvent such as diethyl ether, anisole, and the like, alphatic hydrocarbon solvent such as hexane, pentane, heptane, cyclohexane, octane, isoprene, and the like, aromatic hydrocarbon solvent such as toluene, xylene, benzene, ethylbenzene, naphthalene, and the like, aromatic heterocyclic compounds solvent such as furan, thiophene, and the like, halogen compounds solvent such as chloroform, esters solvent such as ethyl acetate, isopropyl acetate, isobutyl acetate, ethyl acrylate, and the like, nitrites solvent such as acrylonitrile and the like, nitros solvent such as nitromethane, nitroethane, and the like, combinations of one or more kinds of the above solvents, and so on.

The content ratio of the solvent in the mixture solution is not particularly limited, and is preferably 5 to 75 wt %, more preferably 10 to 70 wt %, still more preferably 15 to 65 wt %. If the content ratio of the solvent is less than the lower limit, it may be difficult to dissolve the mixture sufficiently depending on the solubility of the mixture to the solvent. On the other hand, if the content of the solvent exceeds the upper limit, time taken to remove the solvent in a later process becomes long, thereby deteriorating productivity of the liquid developer. In addition, if the content ratio of the solvent is too high, components mixed sufficiently uniformly in the above mixture process may be phase-separated, thereby making it difficult to sufficiently decrease irregularity of characteristics of the toner particles in the resultant liquid developer.

In addition, at least a portion of the components of the mixture may be dissolved (including being swelled) in the mixture solution, and insoluble portions may exist in the mixture solution.

### Preparation of Aqueous Emulsified Solution

Next, the aqueous emulsified solution is obtained by mixing the above mixture solution with the aqueous liquid. In the aqueous emulsified solution, the dispersoids including the above solvent and the components of the mixture are dispersed in the aqueous dispersion medium composed of the aqueous liquid.

In the specification, “aqueous liquid” refers to liquid including at least water (H₂O), and preferably is mainly composed of water. The content ratio of water in the aqueous liquid is preferably more than 50 wt %, more preferably more than 80 wt %, still more preferably more than 90 wt %. In addition, the aqueous liquid may include components other than water. For example, the aqueous liquid may include a component having excellent solubility with water (for example, material having solubility of more than 30 g with respect to water of 100 g at 25° C.). Such a component may include, for example, alcohols solvent such as methanol, ethanol, propanol, and the like, ethers solvent such as 1,4-dioxan, tetrahydrofurane (THF), and the like, aromatic heterocyclic compounds solvent such as pyridine, pyrazine, pyrrole, and the like, amides solvent such as N,N-dimethylformamide (DMF), N,N-dimethylacetamide (DMA), nitrites solvent such as acetonitrile and the like, aldehydes solvent such as acetaldehyde and the like, and so on.

In addition, for preparation of the aqueous emulsified solution, for example, a dispersing agent or the like may be used in order to improve dispersibility of the dispersoids. The dispersing agent may include, for example, inorganic dispersing agent such as viscous mineral, silica, tricalcium phosphate, and the like, nonionic dispersing agent such as polyvinyl alcohol, carboxymethyl cellulose, polyethylene glycol, and the like, anionic organic dispersing agent such as tri-stearic acid metal salt (for example, aluminum salt, etc.), di-stearic acid metal salt (for example, aluminum salt, barium salt, etc.), stearic acid metal salt (for example, calcium salt, lead salt, zine salt, etc.), linolenic acid metal salt (for example, cobalt salt, manganese salt, lead salt, zine salt), octanoic acid metal salt (for example, aluminum salt, calcium salt, cobalt salt, etc.), palmitic acid metal salt (for example, zine salt, etc.), dodecylbenzene sulfon metal salt (for example, sodium salt, etc.), naphthenic acid metal salt (for example, calcium salt, cobalt salt, manganese salt, lead salt, zine salt, etc.), resinic acid metal salt (for example, calcium salt, cobalt salt, zine salt, etc.), polyacrylic acid metal salt (for example, sodium salt, etc.), polymethacrylic acid metal salt (for example, sodium salt, etc.), polymaleic acid metal salt (for example, sodium salt, etc.), polyacrylic acid-co-maleic acid metal salt (for example, sodium salt, etc.), polystyrene sulfon metal salt (for example, sodium salt, etc.), and the like, cationic organic dispersing agent such as quaternary ammonium, and so on. By using the above dispersing agent for preparation of the aqueous emulsified solution, it is possible to improve dispersibility of the dispersoids, relatively easily make the irregularity of shape and size of the dispersoids in the aqueous emulsified solution particularly small, and turn dispersoids into a roughly spherical shape.

It is preferable that the mixture solution is mixed with the aqueous liquid while agitating at least one of the mixture solution and the aqueous liquid. This makes it possible to easily and reliably obtain the emulsified solution (aqueous emulsified solution) in which dispersoids having small irregularity of size and shape are dispersed.

An example of a method of mixing the mixture solution with the aqueous liquid may include a method of adding the mixture solution in the aqueous liquid in a container (for example, a dripping method), a method of adding the aqueous liquid in the mixture solution in a container (for example, a dripping method), etc. In these methods, it is preferable to add at least one liquid in the other liquid which is being agitated. This allows the above-described effects to be shown more remarkably.

The content ratio of dispersoids in the aqueous emulsified solution is not particularly limited, and is preferably 5 to 55 wt %, more preferably 10 to 50 wt %. This makes it possible to more reliably prevent the dispersoids in the aqueous emulsified solution from being combined (conglomerated) and provides excellent productivity of the toner particles (liquid developer).

An average diameter of the dispersoids in the aqueous emulsified solution is not particularly limited, and is preferably 0.03 to 1.8 μm, more preferably 0.1 to 1.6 μm, still more preferably 0.2 to 1.4 μm. This makes it possible to more reliably prevent the dispersoids in the aqueous emulsified solution from being combined (conglomerated) and optimizes size of the resultant toner particles.

In addition, although it has been illustrated in the above description that the components of the mixture are included in the dispersoids, some of the components of the mixture may be included in the dispersion medium.

In addition, components other than the above components may be included in the aqueous emulsified solution. Such components may include, for example, charging control agent, magnetic powder, etc.

The charge control agent may include, for example, metal salt of benzoic acid, metal salt of salicylic acid, metal salt alkylsalicylic acid, metal salt of catechol, metal-contained bisazo dyes, nigrosine dye, tetraphenylborate derivative, quaternary ammonium salt, alkylpyridinium salt, chlorinated polyester, nitrohuminic acid, and the like.

The magnetic powder may include, for example, metal oxide such as magnetite, maghemite, ferrites, cupric oxide, nickel oxide, zinc oxide, zirconium oxide, titanium oxide, magnesium oxide, and the like, magnetic materials including Fe, Co, Ni, and the like.

In addition to the above-mentioned materials, zinc stearate, zinc oxide, cerium oxide, etc. may be included in the aqueous emulsified solution.

### Aqueous Suspension Preparing Process

The aqueous emulsified solution obtained as above may be, as it is, provided for the corpuscle combiner manufacturing process which will be described later. However, in this embodiment, an aqueous suspension 6 in which solidified dispersoids 61 are dispersed in a dispersion medium (aqueous dispersion medium) 62 is obtained from the aqueous emulsified solution (in which the liquefied dispersoids are dispersed in the aqueous dispersion medium), and then, the obtained aqueous suspension 6 is provided for the corpuscle combiner manufacturing process.

Hereinafter, a method of preparing the aqueous suspension 6 will be described in detail.

The aqueous suspension 6 can be prepared by removing a solvent composing dispersoids from the aqueous emulsified solution.

Although the solvent can be removed by, for example, heating the aqueous emulsified solution or putting the aqueous emulsified solution under a reduced pressure atmosphere, it is preferable to heat the aqueous emulsified solution at a reduced pressure. This makes it possible to relatively easily obtain the aqueous suspension 6 having very small irregularity of size and shape of the dispersoids 61. In addition, while the solvent is removed, gas can be removed together. This makes it possible to reduce the amount of dissolved gas in the aqueous suspension 6 and effectively prevent bubbles from being produced out of the aqueous suspension 6 when the dispersion medium 62 is removed from a discharged aqueous suspension 6 in a dispersion medium remover 3 of a corpuscle combiner manufacturing apparatus 1. As a result, it is possible to effectively prevent abnormal toner particles (hollow particles, deficient particles, and the like) from being mixed in the resultant liquid developer.

When the aqueous emulsified solution is heated, heating temperature is preferably 30 to 110° C., more preferably 40 to 100° C. If the heating temperature is within the above range, it is possible to promptly remove the solvent while sufficiently preventing dispersoids 61 having abnormal shape from being produced (reliably preventing the solvent from being suddenly vaporized (boiled) from the inside of the dispersoids of the aqueous emulsified solution.

In addition, when the aqueous emulsified solution is placed under a reduced pressure atmosphere, pressure of the atmosphere in which the aqueous emulsified solution is placed is preferably 0.1 to 50 kPa, more preferably 0.5 to 5 kPa. If the pressure of the atmosphere in which the aqueous emulsified solution is placed is within the above range, it is possible to promptly remove the solvent while sufficiently preventing dispersoids 61 having abnormal shape from being produced (reliably preventing the solvent from being suddenly vaporized (boiled) from the inside of the dispersoids of the aqueous emulsified solution.

In addition, the solvent may be removed in such an order that at least the dispersoids are solidified without need to remove substantially all the solvent included in the aqueous emulsified solution.

An average diameter of the dispersoids 61 in the aqueous suspension 6 is not particularly limited, and is preferably 0.05 to 1.5 μm, more preferably 0.1 to 1.3 μm, still more preferably 0.20 to 1.2 μm. This makes it possible to more reliably prevent the dispersoids from being combined (conglomerated) and optimizes size of the resultant toner particles.

### Corpuscle Combiner Manufacturing Process

Next, by removing the aqueous dispersion medium from the aqueous suspension 6 (aqueous dispersion solution), a corpuscle combiner which is a combination of a plurality of dispersoids (corpuscles) in the aqueous suspension 6 (aqueous dispersion solution) is obtained (corpuscle combiner manufacturing process). The obtained corpuscle combiner can be used as the toner particles of the liquid developer.

The aqueous dispersion medium may be removed using any methods. In this embodiment, it is preferable to include a discharging step of intermittently discharging liquid drops of the aqueous suspension (aqueous dispersion solution) in which the dispersoids are dispersed in the aqueous dispersion medium and a dispersion medium removing step (combining step) of removing the dispersion medium by heating and decompressing the aqueous suspension. In the discharging step, by intermittently discharging the liquid drops, which are uniform in size, of the aqueous suspension, it is possible to make size of corpuscle combiners after removal of the dispersion medium uniform. In addition, while the dispersion medium is removed in the dispersion medium removing step (combining step), corpuscles (dispersoids) in the liquid drops are conglomerated to efficiently generate corpuscle combiners having unevenness. In addition, by intermittently discharging the liquid drops, it is possible to more efficiently remove the aqueous dispersion medium while effectively preventing dispersoids in other liquid drops from being conglomerated. In addition, by removing the aqueous dispersion medium by intermittently discharging the liquid drops of the aqueous suspension (aqueous dispersion solution), even when some of the solvent remains in preparing the above aqueous suspension, it is possible to efficiently remove the remaining solvent along with the aqueous dispersion medium.

Particularly, in this embodiment, the aqueous dispersion medium is removed using the corpuscle combiner manufacturing apparatus (toner particle manufacturing apparatus) as shown in FIGS. 1 and 2.

### Corpuscle Combiner Manufacturing Apparatus

As shown in FIG. 1, a corpuscle combiner manufacturing apparatus 1 includes a head unit 2 that intermittently discharges the above-described aqueous suspension (aqueous dispersion solution) 6 as liquid drops, an aqueous suspension supply unit (aqueous dispersion solution supply unit) 4 that supplies the aqueous suspension 6 to the head unit 2, a dispersion medium removing unit 3 that removes the dispersion medium 62 from the aqueous suspension 6, which has a liquid drop shape, discharged from the head unit 2, while carrying the aqueous suspension 6, and a collection unit 5 that collects manufactured corpuscle combiners 9.

The aqueous suspension supply unit 4 has only to supply the aqueous suspension 6 to the head unit 2, but, as shown in the figure, may include an agitating unit 41 that agitate the aqueous suspension 6. This can sufficiently uniformly disperse the dispersoids 61, even when the dispersoids 61 are hardly dispersed in the dispersion medium (aqueous dispersion medium) 62, and supply the aqueous suspension 6 including the dispersed dispersoids 61 to the head unit 2.

The head unit 2 discharges the aqueous suspension 6 as fine liquid drops (corpuscles). The shown head unit 2 can make size of the discharged liquid drops uniform.

The head unit 2 includes a dispersion solution retention unit 21, a piezoelectric device 22, and a discharge unit 23.

The aqueous suspension 6 is retained in the dispersion solution retention unit 21.

The aqueous suspension 6 retained in the dispersion solution retention unit 21 is discharged as liquid drops from the discharge unit 23 to the dispersion medium removing unit 3 by a pressure pulse of the piezoelectric device 22 (piezoelectric pulse).

The discharge unit 23 is not particularly limited in its shape, and has preferably a roughly circular shape. This can make irregularity of size of the aqueous suspension 6 or the corpuscle combiners 9 formed in the dispersion medium removing unit 3 very small.

When the discharge unit 23 has the roughly circular shape, for example, its diameter (nozzle diameter) is preferably 5 to 500 μm, more preferably 10 to 200 μm. If the diameter of the discharge unit 23 is less than the lower limit, clogging is likely to occur, thereby increasing irregularity of size of the discharged liquid drops. On the other hand, the diameter of the discharge unit 23 exceeds the upper limit, there is a possibility that the discharged liquid drops of the aqueous suspension 6 drag bubble in depending on a relationship between a negative pressure of the dispersion solution retention unit 21 and a surface tension of a nozzle.

In addition, it is preferable that the neighborhood of the discharge unit 23 of the head unit 2 (particularly, an inner side of opening of the discharge unit 23, or a side at which the discharge unit 23 of the head unit 2 is provided (a lower side in FIG. 2) has liquid repellent (water repellent) property for the aqueous suspension 6. This can effectively prevent the aqueous suspension 6 from being adhered near the discharge unit 23. As a result, it is possible to prevent a so-called liquid exhaustion effect and discharge badness of the aqueous suspension 6. In addition, by effectively preventing the aqueous suspension 6 from being adhered near the discharge unit, it is possible to improve stability of shape of the discharged liquid drops (as irregularity of shape and size of the liquid drops becomes small) and make irregularity of shape and size of the resultant toner particles small.

Materials having such liquid repellent property may include, for example, fluorine resin such as polytetrafluoroethylene (PTFE), silicon material and the like.

As shown in FIG. 2, the piezoelectric device 22 includes a lower electrode (first electrode) 221, a piezoelectric film 222 and an upper electrode (second electrode) 223 which are laminated in order. In other words, the piezoelectric device 22 has the structure that the piezoelectric film 222 is interposed between the upper electrode 223 and the lower electrode 221.

The piezoelectric device 22 functions as a vibration source, and a diaphragm 24 is vibrated by vibration of the piezoelectric device (vibration source) 22, thereby instantaneously increasing an internal pressure of the dispersion solution retention unit 21.

In a condition where a predetermined discharge signal is not inputted from a piezoelectric device driving circuit (not shown) to the head unit 2, that is, a voltage is not applied between the lower electrode 221 and the upper electrode 223 of the piezoelectric device 22, the piezoelectric film 222 is not deformed. Accordingly, the diaphragm 24 is not also deformed, and thus, volume of the dispersion solution retention unit 21 is not varied. Accordingly, the aqueous suspension 6 is not discharged from the discharge unit 23.

On the other hand, in a condition where a predetermined discharge signal is inputted from the piezoelectric device driving circuit to the head unit 2, that is, a voltage is applied between the lower electrode 221 and the upper electrode 223 of the piezoelectric device 22, the piezoelectric film 222 is deformed. This causes the diaphragm 24 to be greatly bent (downward in FIG. 2), thereby reducing (varying) the volume of the dispersion solution retention unit 21. At this time, the internal pressure of the dispersion solution retention unit 21 suddenly increases, thereby discharging the granular aqueous suspension 6 from the discharge unit 23.

When the discharge of the aqueous suspension 6 is completed one time, the piezoelectric device driving circuit stops the application of voltage between the lower electrode 221 and the upper electrode 223. Accordingly, the piezoelectric device 22 returns to its original shape, thereby increasing the volume of the dispersion solution retention unit 21. At this time, a positive pressure from the aqueous suspension supply unit 4 to the discharge unit 23 acts on the aqueous suspension 6. Accordingly, air is prevented from being inserted in the dispersion solution retention unit 21 from the discharge unit 23, so that the aqueous suspension 6 of the amount according to the discharge amount of the aqueous suspension 6 is supplied from the aqueous suspension supply unit 4 to the dispersion solution retention unit 21.

By applying the voltage with a predetermined period, the piezoelectric device 22 is vibrated so that the granular aqueous suspension 6 is repeatedly discharged.

In this manner, by discharging (jetting) the aqueous suspension 6 with the pressure pulse by the vibration of the piezoelectric film 222, the aqueous suspension 6 can be intermittently discharged drop by drop, and shape of liquid drops of the discharged aqueous suspension 6 is stabilized.

As a result, it is possible to make irregularity of shape and size of the toner particles very small.

In addition, by using the vibration of the piezoelectric film to discharge the aqueous suspension 6, it is possible to more reliably discharge the aqueous suspension at predetermined intervals. This can effectively prevent the discharged liquid drops from being collided and conglomerated, thereby more effectively preventing corpuscle combiners 9 having an abnormal shape from being formed.

A first speed of the liquid drops of the aqueous suspension 6 discharged from the head unit 2 to the dispersion medium removing unit 3 is preferably 0.1 to 10 m/second, more preferably 2 to 8 m/second. If the first speed of the liquid drops of the aqueous suspension 6 is less than the lower limit, productivity of the toner is lowered. On the other hand, if the first speed of the liquid drops of the aqueous suspension 6 exceeds the upper limit, the shape of the corpuscle combiners 9 becomes irregular.

In addition, viscosity of the aqueous suspension 6 discharged from the head unit 2 is not particularly limited, and is preferably 0.5 to 200 μmPa·s], more preferably 1 to 25 [mPa·s]. If the viscosity of the aqueous suspension 6 is less than the lower limit, it is difficult to sufficiently control size of the discharged aqueous suspension 6, thereby making irregularity of the resultant toner particles large. On the other hand, if the viscosity of the aqueous suspension 6 exceeds the upper limit, the diameter of formed particles becomes large, thereby decreasing the discharge speed of the aqueous suspension 6 and increasing energy required to discharge the aqueous suspension 6. In addition, if the viscosity of the aqueous suspension 6 is particularly large, it is not possible to discharge the aqueous suspension 6 as liquid drops.

In addition, the aqueous suspension 6 discharged from the head unit 2 may be cooled in advance. By cooling the aqueous suspension 6, it is possible to effectively prevent the dispersion medium 62 from being unintentionally vaporized (volatilized) out of the aqueous suspension 6 in the vicinity of the discharge unit 23, for example. As a result, it is possible to effectively prevent the discharge amount of the aqueous suspension 6 from being varied due to decrease of an opening area of the discharge unit, thereby making irregularity of size and shape of the toner particles very small.

The discharge amount of one drop of the aqueous suspension 6 is preferably 0.05 to 500 pl, more preferably 0.5 to 50 pl depending on the content ratio of the dispersoids 61 in the aqueous suspension 6. When the discharge amount of one drop of the aqueous suspension 6 is within this range, the formed corpuscle combiners 9 can have an appropriate diameter.

In addition, an average diameter of the liquid drops discharged from the head unit 2 is preferably 1.0 to 100 μm, more preferably 5 to 50 μm depending on the content ratio of the dispersoids 61 in the aqueous suspension 6. When the average diameter of liquid drops is within this range, the formed corpuscle combiners 9 can have an appropriate diameter.

The number of vibrations of the piezoelectric device 22 (frequency of the piezoelectric pulse) is not particularly limited, and is preferably 1 kHz to 500 MHz, more preferably 5 kHz to 200 MHz. If the number of vibrations of the piezoelectric device 22 is less than the lower limit, productivity of toner is lowered. On the other hand, if the number of vibrations of the piezoelectric device 22 exceeds the upper limit, it is not possible to keep up with the discharge of the granular aqueous suspension 6, and irregularity of size of one drop of the aqueous suspension 6 becomes large, which results in increase of irregularity of size of the formed corpuscle combiners 9.

The shown corpuscle combiner manufacturing apparatus 1 has a plurality of head units 2. Liquid drops of the granular aqueous suspension 6 are discharged from the head units 2 to the dispersion medium removing unit 3.

The head units 2 may discharge the liquid drops of the aqueous suspension 6 at the about same time. However, it is preferable that at least two adjacent head units have different discharge timings of the liquid drops of the aqueous suspension 6. This can effectively prevent the liquid drops from being collided and unintentionally conglomerated before the corpuscle combiners 9 are formed from the liquid drops discharged from the adjacent head units 2.

In addition, as shown in FIG. 1, the corpuscle combiner manufacturing apparatus 1 has a gas supply unit 10. Gas supplied from the gas supply unit 10 is jetted at an about uniform pressure from gas nozzles 7 provided between the adjacent head units 2 via a duct 101. This makes it possible to form the corpuscle combiners 9 while maintaining intervals of liquid drops intermittently discharged from the discharge unit 23 and effectively preventing the liquid drops from being collided. As a result, it is possible to make irregularity of size and shape of the formed corpuscle combiner 9 smaller.

In addition, by jetting the gas, which is supplied from the gas supply unit 10, from the gas nozzles 7, it is possible to form a gas stream flowing in one direction (downward in the figure) in the dispersion medium removing unit 3. When the gas stream is generated, it is possible to more efficiently carry the corpuscle combiners 9 formed in the dispersion medium removing unit 3. This improves efficiency of collection of the corpuscle combiners 9, thus increasing the productivity of the liquid developer.

In addition, by jetting the gas from the gas nozzles 7, an air stream curtain is formed between the liquid drops discharged from the head units 2, thereby making it possible to more effectively prevent the liquid drops discharged from the adjacent head units from being collided and conglomerated.

In addition, the gas supply unit 10 is equipped with a heat exchanger 11. The heat exchanger 11 can set temperature of the gas jetted from the gas nozzles 7 to be a desired value and efficiently remove the dispersion medium 62 from the granular aqueous suspension 6 discharged to the dispersion medium removing unit 3.

In addition, the gas supply unit 10 makes it possible to easily control a speed of removal of the dispersion medium 62 from the aqueous suspension 6 discharged from the discharge unit 23 by adjusting the amount of supply of the gas stream.

The temperature of the gas jetted from the gas nozzles 7 is preferably 0 to 70° C., more preferably 15 to 60° C. depending on compositions of the dispersoids 61 and the dispersion medium 62 included in the aqueous suspension 6. When the temperature of the gas jetted from the gas nozzles 7 is within this range, it is possible to efficiently remove the dispersion medium 62 included in the liquid drops while sufficiently increasing regularity and stability of shape of the obtained corpuscle combiners 9.

In addition, humidity of the gas jetted from the gas nozzles 7 is preferably less than 50% RH, more preferably less than 30% RH. When the humidity of the gas jetted from the gas nozzles 7 is less than 50% RH, it is possible to efficiently remove the dispersion medium 62 from the aqueous suspension 6 in the dispersion medium removing unit 3 which will be described later, thus further increasing the productivity of the corpuscle combiners 9.

The dispersion medium removing unit 3 has a tube-like housing 31. For the purpose of maintaining the internal temperature of the dispersion medium removing unit 3 within a predetermined range, for example, a heater or a cooler may be installed at an inner or outer side of the housing 31, or the housing 31 may be formed with a jacket having a passage of heating medium or cooling medium.

In addition, in the shown configuration, an internal pressure of the housing 31 is adjusted by a pressure adjusting unit 12. In this manner, by adjusting the internal pressure of the housing 31, it is possible to more efficiently form the corpuscle combiners 9, thus increasing the productivity of the liquid developer. In addition, in the shown configuration, the pressure adjusting unit 12 is connected to the housing 31 via a connecting pipe 121. In addition, a diameter enlargement portion 122 having its enlarged inner diameter and a filter 123 to prevent absorption of the corpuscle combiners 9 and so on are formed near one end of the connecting pipe which is connected to the housing 31 of the connecting pipe 121.

The internal pressure of the housing 31 is not particularly limited, and is preferably less than 150 kPa, more preferably 100 to 120 kPa, still more preferably 100 to 110 kPa. If the internal pressure of the housing 31 is within the this range, it is possible to effectively prevent the dispersion medium 62 from being suddenly removed (boiled) from the liquid drops, thereby making it possible to more efficiently manufacture the corpuscle combiners 9 while sufficiently preventing the corpuscle combiners 9 having an abnormal shape from being produced. In addition, the internal pressure of the housing 31 may be about the same at different portions or may be varied depending on portions.

In addition, a voltage applying unit 8 to apply a voltage is connected to the housing 31. When the voltage applying unit 8 applies a voltage having the same polarity as the corpuscle combiners 9 (the liquid drops of the aqueous suspension 6) to the inner side of the housing 31, the following effects are obtained.

Typically, the corpuscle combiners 9 and so on are negatively or positively charged. Accordingly, if there is a charged material with a polarity different from that of the corpuscle combiners 9, the corpuscle combiners 9 are attracted to the charged material by an electrostatic force. On the other hand, if there is a charged material with the same polarity as the corpuscle combiners 9, the corpuscle combiners 9 are repelled from the charged material, thereby effectively preventing the corpuscle combiners 9 from being adhered to the charged material. Accordingly, by applying a voltage having the same polarity as the granular corpuscle combiners 9 to the inner side of the housing 31, it is possible to effectively prevent the corpuscle combiners 9 from being adhered to the inner side of the housing 31. This can increase collection efficiency of the corpuscle combiners 9 while more effectively preventing the corpuscle combiners 9 having an abnormal shape from being produced.

In addition, the housing 31 has a diameter reduction portion 311 near the collection unit 5, which has an inner diameter decreasing in a downward direction in FIG. 1. The diameter reduction portion 311 makes it possible to efficiently collect the corpuscle combiners 9.

The corpuscle combiners 9 formed as above are collected to the collection unit 5.

When the aqueous suspension 6 discharged from the head units 2 are carried to the dispersion medium removing unit 3 in which the aqueous suspension 6 is solidified, a plurality of corpuscles derived from the dispersoids 61 are conglomerated to form the corpuscle combiners 9. That is, while the dispersion medium 62 are removed from the discharged aqueous suspension 6, the dispersoids 61 included in the aqueous suspension 6 are conglomerated to form the corpuscle combiners 9. In addition, if the above-described solvent is included in the dispersoids 61, the solvent is also removed in the dispersion medium removing unit 3. Typically, the dispersoids 61 included in the aqueous suspension 6 are sufficiently smaller in diameter than the formed corpuscle combiners (the discharged granular aqueous suspension 6). Accordingly, the corpuscle combiners obtained by drying the relatively uniform amount of liquid drops of the aqueous suspension 6 consist of the relatively uniform number of corpuscles, thereby making irregularity of size and characteristics of the corpuscle combiners small.

In addition, since the dispersion medium 61 is removed in the solidification unit 3, the corpuscle combiners are typically smaller than the liquid drops of the aqueous suspension 6 discharged from the discharge unit 23. On this account, even if an area of the discharge unit 23 is relatively large, it is possible to make size of the obtained corpuscle combiners 9 relatively small. Accordingly, in this embodiment, it is possible to obtain sufficiently fine corpuscle combiners 9 even through the head units 2 are not machined with high precision (that is, manufactured with relative ease). In addition, since the area of the discharge unit 23 need not be extremely small, it is possible to sufficiently sharpen a granularity distribution of the aqueous suspension 6 discharged from the head units 2 with relative ease. As a result, the obtained corpuscle combiners 9 have small irregularity of particle diameter, that is, a sharp granularity distribution.

In addition, the corpuscle combiners 9 become granular materials obtained when the dispersion medium 62 is removed from the aqueous suspension 6, and, for example, some of the dispersion medium may remain in the inside of corpuscle combiners 9.

The corpuscle combiners 9 may be, as they are, provided for a dispersing process, or may be subject to various processes such as a classifying process, an additive adding process, a drying process and the like.

### Dispersing Process

A dispersing process is to disperse the above obtained corpuscle combiners in insulating liquid including unsaturated fatty acid glyceride composing the liquid developer to obtain the liquid developer in which the corpuscle combiners are dispersed as toner particles. By dispersing the corpuscle combiners in the insulating liquid including the unsaturated fatty acid glyceride, the unsaturated fatty acid glyceride can be efficiently maintained in unevenness of the corpuscle combiners. In addition, after dispersing the corpuscle combiners in some of components of the insulating liquid, the remaining components may be added. For example, if the insulating liquid includes unsaturated fatty acid glyceride and fatty acid monoester, after dispersing the corpuscle combiners in the fatty acid monoester, the unsaturated fatty acid glyceride may be added.

### Liquid Developer

According to the liquid developer manufacturing method described as above, the liquid developer having a very narrow granularity distribution of toner particles and very small irregularity of shape and characteristics of the toner particles is obtained. In addition, since vegetable oil is used as the insulating liquid, the manufactured liquid developer is safe and environmental-friendly.

When such a liquid developer is used, it is possible to provide excellent development ability, transferability and increased strength of fixation of the toner particles onto a recording medium and obtain an image having high resolution. In addition, such a liquid developer is advantageous to electrophoresis of toner particles in the insulating liquid (liquid developer) and high speed development.

Although the method of discharging the dispersion solution of the dispersoids including resin and coloring agent has been illustrated as the liquid developer manufacturing method according to the exemplary embodiments, the liquid developer manufacturing method is not limited to the above-described method.

For example, the corpuscle combiners may be formed by means of an emulsion polymerization method of preparing resin dispersion solution by emulsion polymerization, preparing coloring agent dispersion solution in which a coloring agent is dispersed in a solvent, and mixing and conglomerating the resin dispersion solution and the coloring agent dispersion solution to obtain particles having combined corpuscles. In a conglomerating step, resin particles and coloring agent particles in a dispersion solution mixture in which the resin dispersion solution is mixed with the coloring agent dispersion solution are conglomerated to form the corpuscle combiners. The corpuscle combiners are formed by hetero conglomeration and may also be formed by adding ionic surfactant having polarity different from that of the corpuscle combiners or compounds having univalent or more electric charges, such as metal salts in order to stabilize the corpuscle combiners and control granularity/granularity distribution of the corpuscle combiners. The corpuscle combiners can be easily manufactured using the above-described method. In addition, the toner particles can be manufactured at a relatively low temperature, and resin having a relatively low softening temperature may be used. Thus, when the obtained corpuscle combiners are used as the toner particles, it is possible to provide excellent high speed print aptitude.

In addition, the corpuscle combiners may be subject to a thermal treatment under a temperature condition of more than glass transition temperature of resin for combination of corpuscles. This makes it possible to increase combination of corpuscles and control depth of the unevenness of the corpuscle combiners at random. In addition, when corpuscles are combined by the thermal treatment, it is possible to further decrease the content of water in the corpuscle combiners.

In addition, by deagglomerating the corpuscle combiners in the insulating liquid, it is possible to obtain a liquid developer in which deagglomerations are dispersed as toner particles. Since the corpuscle combiners are deagglomerated in the insulating liquid, it is possible to prevent large toner particles from being produced due to conglomeration. In addition, when the corpuscle combiners are deagglomerated, it is possible to easily maintain the insulating liquid in the unevenness of surfaces of the toner particles derived from the corpuscles (dispersoids), thereby increasing dispersibility of the toner particles. In addition, since the toner particles are obtained by deagglomerating the corpuscle combiners, it is possible to effectively prevent microscopic particles (particles extremely smaller than particles having a desired size) as compared to traditional pulverizing methods or a wet pulverizing method. As a result, it is possible to effectively prevent charging characteristics of the resultant liquid developer and the like from being deteriorated.

In addition, if the corpuscle combiners are deagglomerated using some of the insulating liquid, liquid which is the same as or different from the liquid used for the deagglomeration may be added as insulating liquid after the deagglomeration. If liquid different from the liquid used for the deagglomeration is added, it is possible to easily adjust characteristics such as viscosity of the resultant liquid developer. For example, by deagglomerating the corpuscle combiners in insulating liquid having low viscosity, such as fatty acid monoester, and then adding insulating liquid having relatively high viscosity, such as unsaturated fatty acid glyceride, it is possible to easily adjust the viscosity. In addition, by deagglomerating the corpuscle combiners in insulating liquid having low viscosity, it is possible to deagglomerate the corpuscle combiners with high efficiency.

### Image Forming Method and Image Forming Apparatus

Next, an image forming method and an image forming apparatus using the above-described liquid developer in accordance to embodiments of the invention will be described. The image forming apparatus has a mechanism that fixes the above-described liquid developer (toner particles) onto a recording medium to which the toner particles are adhered by heating and pressurizing the recording medium.

### First Embodiment

To begin with, an image forming apparatus according to a first embodiment of the invention will be described.

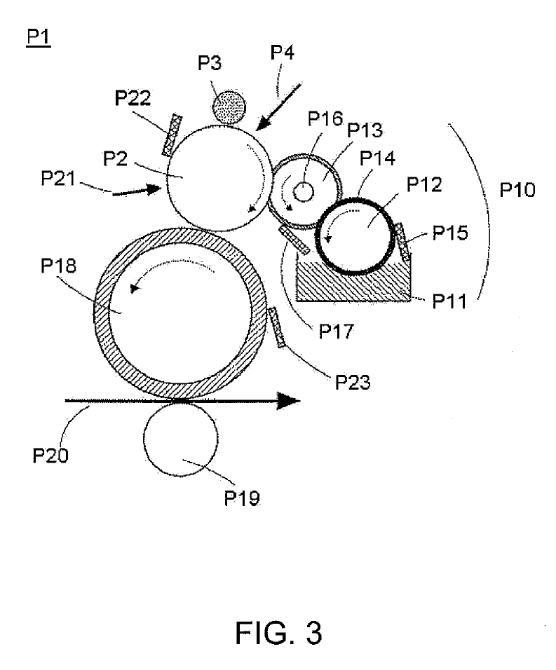

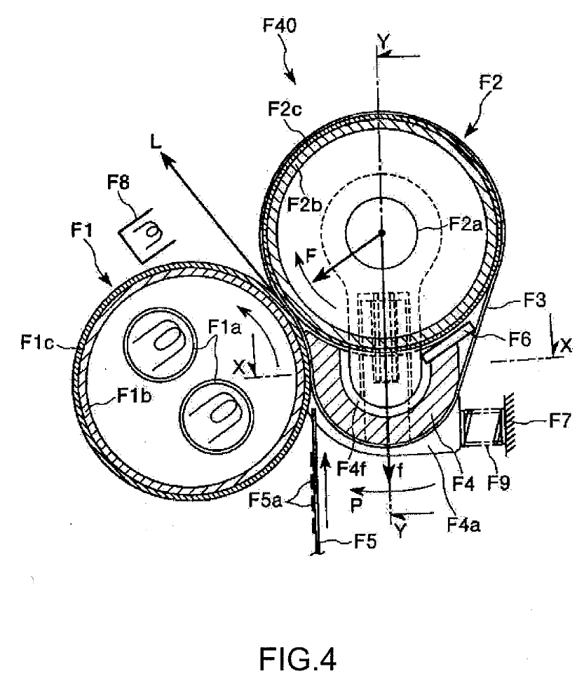

FIG. 3 shows an example of an image forming apparatus according to an embodiment of the invention, and FIG. 4 is a sectional view showing an example of a fixing unit included in the image forming apparatus shown in FIG. 3. FIG. 3 shows the image forming apparatus without a fixing unit. In an image forming apparatus P1, a surface of a photoconductor drum P2 is uniformly charged by a charger P3 made of epichlorohydrin rubber or the like, and then, exposure P4 according to information the charged surface is performed for the charged surface by means of a laser diode or the like to form an electrostatic latent image.

A developing unit P10 has a coating roller P12, a portion of which is dipped in a developer container P11, and a developing roller P13. The coating roller P12 is a gravure roller made of metal such as stainless steel and rotates in the opposite of the developing roller P13. In addition, a liquid developer coating layer P14 is formed on a surface of the coating roller P12, and a metering blade P15 keeps thickness of liquid developer coating layer P14 constant.

A liquid developer is transferred from the coating roller P12 to the developing roller P13. The developing roller P13 includes a roller core P16 made of metal such as stainless steel. A silicon rubber layer is coated on the roller core P16, and a resin layer made of polytetrafluoroethylene-perfluorovinylether copolymer (PFA) is formed on a surface of the silicon rubber layer. The developing roller P13 rotates at the same speed as the photoconductor P2 to transfer the liquid developer to a latent image portion of the photoconductor P2. Liquid developer remaining in the developing roller P13 after transfer of liquid developer to the photoconductor P2 is removed by a developing roller cleaning blade P17 and is recovered into the developer container P11.

After transfer a toner image from the photoconductor to an intermediate transfer roller, the photoconductor is de-electrified by de-electrifying light P21, and toner remaining in the photoconductor is removed by a cleaning blade P22 made of urethane rubber or the like.

Likewise, after transfer the toner image from the intermediate transfer roller P18 to an information recording medium P20, toner remaining in the intermediate transfer roller P18 is removed by a cleaning blade P23 made of urethane rubber or the like.

After the toner image formed on the photoconductor P2 is transferred to the intermediate transfer roller P18, transfer current is applied to a second transfer roller P19. Then, a toner image is transferred to the information recording medium P20, such as sheet, which passes between both rollers P18 and P19, and the toner image on the information recording medium P20 such as sheet is fixed by a fixing unit shown in FIG. 4. Although it has been illustrated in the above that an image is formed using the liquid developer having a single color, if an image is to be formed using color toner having a plurality of colors, a color image can be formed by forming images having different colors using developing units having a plurality of colors.

FIG. 4 is a sectional view showing a fixing unit included in the image forming apparatus according to the embodiment of the invention.

As shown in FIG. 4, a fixing unit F40 includes a thermal fixing roll (hereinafter also referred to as a heating roll) F1, a pressing roll F2, a heat-resistant belt F3, a belt suspending member F4 and a cleaning member F6.

The thermal fixing roll F1 includes a roll base F1b made of a pipe having an outer diameter of 25 mm or so and a thickness of 0.7 mm or so, an elastic film F1c which is coated on the circumference of the roll base F1b and has a thickness of 0.4 mm, and 1,050 W two pillar-like halogen lamps F1a as a heat source which are contained within the roll base F1b. The thermal fixing roll F1 can be rotated in a counterclockwise direction as shown by an arrow in FIG. 4. In addition, the pressing roll F2 includes a roll base F2b made of a pipe having an outer diameter of 25 mm or so and a thickness of 0.7 mm or so, and an elastic film F2c which is coated on the circumference of the roll base F2b and has a thickness of 0.2 mm. A pressing force acting between the thermal fixing roll Fl and the pressing roll F2 is less than 10 kg, and a nip length is 10 mm or so. The pressing roll F2 faces the thermal fixing roll F1 and can be rotated in a clockwise direction as shown by an arrow in FIG. 4.

In this manner, since the outer diameters of the thermal fixing roll F1 and pressing roll F2 are so small as 25 mm or so, a sheet F5 is not rolled on the thermal fixing roll F1 or the heat-resistant belt F3, without requiring means for taking the sheet F5 off. In addition, if a PFA layer having a thickness of about 30 μm is coated on a surface of the elastic film F1c of the thermal fixing roll F1, the strength of the thermal fixing roll F1 is further increased so much. Accordingly, although the thickness of elastic film F1c is different from the thickness of elastic film F2c, since both elastic films F1c and F2c make roughly uniform elastic deformation to form a so called horizontal nip and there occur no difference between a rotational speed of the thermal fixing roll F1 and a carrying speed of the heat-resistant belt F3 or the sheet F5, it is possible to provide very stable image fixation.

In addition, the thermal fixing roll F1 includes therein the two pillar-like halogen lamps F1a and F1a whose heating elements are disposed at different positions, as a heat source. When the pillar-like halogen lamps F1a and F1a are selectively turned on, it is possible to easily make a temperature control under a condition where a fixing nip portion at which the heat-resistant belt F3 is rolled on the thermal fixing roll F1 is different from a portion at which the belt suspending member F4 contacts the thermal fixing roll F1 and a condition where sheet width is varied.

The heat-resistant belt F3 is an endless annular belt which is movably suspended on circumferences of the pressing roll F2 and belt suspending member F4 and is pressed between the thermal fixing roll F1 and the pressing roll F2. The heat-resistant belt F3 has a thickness of more than 0.03 mm and is formed with a two-layered seamless tube having PFA formed on its front surface (side which contacts the sheet F5) and polyimide formed on its rear surface (side which contacts the pressing roll F2 and the belt suspending member F4). The heat-resistant belt F3 is not limited to this configuration, but may be formed with different configurations of a metal tube such as a stainless steel tube or a nickel electro-casting tube, a heat-resistant resin tube such as a silicon tube, and the like.

The belt suspending member F4 is disposed at a side higher than a fixing nip portion between the thermal fixing roll F1 and the pressing roll F2 in a direction in which the sheet F5 is carried in such a manner that the belt suspending member F4 swings around a rotation axis F2a of the pressing roll F2 in a direction indicated by an arrow P. The belt suspending member F4 is configured to suspend the heat-resistant belt F3 in a tangential direction of the thermal fixing roll F1 in a condition where the sheet F5 does not pass through the fixing nip portion. If a fixing pressure is large at an initial position at which the sheet F5 enters the fixing nip portion, as the entrance may not be smooth, an image may be fixed on the sheet F5 with a leading end of the sheet F5 folded. However, when the heat-resistant belt F3 is suspended in the tangential direction of the thermal fixing roll F1, it is possible to form an introduction port for the sheet F5 through which the sheet F5 can smoothly enter, thereby making stable entrance of the sheet F5 into the fixing nip portion possible.

The belt suspending member F4 is a semilunar belt sliding member that is thrust into an inner circumference of the heat-resistant belt F3 to give a tension f to the heat-resistant belt F3 in cooperation with the pressing roll F2 (the heat-resistant belt F3 is slid on the belt suspending member F4). The belt suspending member F4 is disposed at a position at which the heat-resistant belt F3 is rolled from a tangent line L of a pressing portion between the thermal fixing roll F1 and the pressing roll F2 to the thermal fixing roll F1 to form a nip. A projecting wall F4a is installed at one axial end or both axial ends of the belt suspending member F4. If the heat-resistant belt F3 is biased to one of the axial ends, the projecting wall F4a regulates the bias of the heat-resistant belt F3 to the axial end as the heat-resistant F3 contacts the projecting wall F4a. A spring F9 is interposed between one end of the projecting wall F4a, which is in the opposite side to the thermal fixing roll F1, and a frame F7. By the spring F9, the projecting wall F4a of the belt suspending member F4 is lightly pressed on the thermal fixing roll F1, and the belt suspending member F4 is positioned as it contacts the thermal fixing roll F1.

For the purpose of stably driving the pressing roll F2 when the heat-resistant belt F3 is suspended by the pressing roll F2 and the belt suspending member F4, a coefficient of friction between the pressing roll F2 and the heat-resistant belt F3 may be set to be larger than a coefficient of friction between the belt suspending member F4 and the heat-resistant belt F3. However, the friction coefficient may become unstable due to alien substances intruded between the heat-resistant belt F3 and the pressing roll F2 or between the heat-resistant belt F3 and the belt suspending member F4 or abrasion of contact between the heat-resistant belt F3, the pressing roll F2 and the belt suspending member F4.

Accordingly, diameter of the belt suspending member F4 is set to be smaller than diameter of the pressing roll F2 such that a rolling angle of the heat-resistant belt F3 on the belt suspending member F4 becomes smaller than a rolling angle of the heat-resistant belt F3 on the pressing roll F2. Thus, a length by which the heat-resistant belt F3 slides the belt suspending member F4 becomes short, thereby avoiding unstable factors of temporal change or external disturbance and thus making it possible to stably drive the heat-resistant belt F3 with the pressing roll F2.

In addition, the cleaning member F6 is interposed between the pressing roll F2 and the belt suspending member F4. The cleaning member F5 contacts an inner circumference of the heat-resistant belt F3 to clean alien substances or abrasion powders on the inner circumference of the heat-resistant belt F3. By cleaning the alien substances or the abrasion powders, the heat-resistant belt F3 is refreshed to eliminate the unstable factors of the friction coefficient. In addition, a concave portion F4f is provided in the belt suspending member F4. The concave portion F4f is adapted to collection of the alien substances or the abrasion powders removed from the heat-resistant belt F3.

A position at which the belt suspending member F4 is lightly pressed on the thermal fixing roll F1 becomes a nip initial position, and a position at which the pressing roll F2 is lightly pressed on the thermal fixing roll F1 becomes a nip end position. When the sheet F5 enters from the nip initial position to the fixing nip portion, passes between the heat-resistant belt F3 and the thermal fixing roll F1, and comes out of the nip end position, a non-fixed toner image F5a formed on the sheet F5 is fixed, and, thereafter, is discharged in the tangent direction L of the pressing portion between the thermal fixing roll F1 and the pressing roll F2.

Fixation temperature of the non-fixed toner image F5a is preferably 100 to 200° C., more preferably 100 to 180° C. This fixation temperature facilitates decomposition of the above-described antioxidant, thereby effectively increasing fixation strength of toner particles. In addition, if the fixation temperature is within the above range, it is possible to effectively progress an oxidative polymerization reaction of an unsaturated fatty acid component. This effect becomes more remarkable when an oxidative polymerization accelerator is included in the liquid developer.

In addition, it is preferable to install a device that emits an ultraviolet ray, to a plane in which the toner image F5a of the discharged sheet F5 is formed, such as an ultraviolet irradiation unit F5.

When the non-fixed toner image on the recording medium is heated with a thermal fixing roller and then is irradiated with an ultraviolet ray, an unsaturated fatty acid component sunk into the recording medium is reliably oxidative-polymerized, which contributes to the fixation. Accordingly, the sunk unsaturated fatty acid component of insulating liquid is solidified by heat and ultraviolet ray irradiation, thereby causing an anchor effect and thus strongly fixing toner particles onto the recording medium. In addition, by using the oxidative polymerization reaction of the unsaturated fatty acid component, it is possible to fix toner particles onto the recording medium without need to heat the toner particles at a very high temperature by means of the thermal fixing roller. In addition, since much energy is not required for the fixation, even when time for which the recording medium passes through the fixing nip portion is short, it is possible to sufficiently fix the toner particles into the recording medium using the ultraviolet ray irradiation. That is, since long time is not required for the fixation, it is possible to increase a print speed. In addition, since much energy is not required for the fixation, it is possible to save energy and provide environmental-friendly toner fixation.

### Second Embodiment

Next, an image forming apparatus according to a second embodiment of the invention will be described.

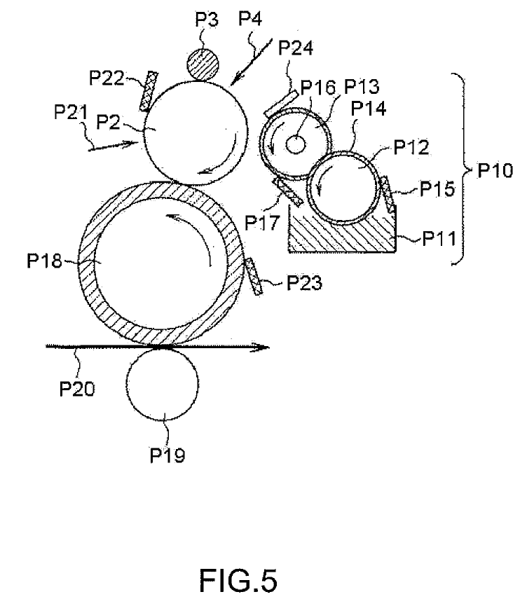

FIG. 5 shows an example of a non-contact type image forming apparatus according to a second embodiment of the invention. In the non-contact type image forming apparatus, a charging blade P24 made of a phosphor bronze plate having a thickness of 0.5 mm is provided in a developing roller P13. The charging blade P24 contacts and frictionally charges a liquid developer layer. In addition, since a coating roller P12 is a gravure roll, and thus, a developer layer is formed on the developing roller P13 due to unevenness of a surface of the gravure roll, the charging blade P24 averages the unevenness uniformly. In addition, the charging blade P24 may be arranged in either a counter direction or a trail direction with respect to a rotation direction of the developing roller and may have a roller shape instead of a blade shape.

It is preferable that a gap of 200 μm to 800 μm is provided between the developing roller P13 and a photoconductor P2 and an alternating voltage of 500 to 3000 Vpp, which has a frequency of 50 to 3000 Hz and overlaps a direction voltage of 200 to 800 V, is applied between the developing roller P13 and the photoconductor P2. Other components of the image forming apparatus shown in FIG. 5 are the same as the image forming apparatus shown in FIG. 3.

When an image is formed using the above-described method and apparatus, by applying heat to the non-fixed toner image F5a when the non-fixed toner image F5a is fixed, an oxidative polymerization reaction of unsaturated fatty acid glyceride added to surfaces of toner particles is raised, and thus, a solidification reaction of insulating liquid between toner particles is raised, thereby making it possible to obtain a toner image having increased fixation strength and high resolution. In addition, even in low temperature-high speed fixation, as a solidification reaction of unsaturated fatty acid glyceride is raised, it is possible to obtain increased fixation strength. In addition, since the fixing process is performed at a low temperature, it is possible to save energy and provide environmental-friendly toner fixation. In addition, when an ultraviolet ray irradiation device is used for the fixation, the above effects become more remarkable.

Although the exemplary modes have been shown and illustrated, the invention is not limited to these modes.

For example, the liquid developer of the invention is not limited to the liquid developer manufactured according to the above-described methods, but may be manufactured using any methods. For example, the liquid developer may be manufactured by thermally melting and dispersing the above-described deagglomerations in the insulating liquid and cooling the dispersed deagglomerations. In this case, if an antioxidant is included in the insulating liquid, it is possible to prevent any deterioration due to oxidation of the unsaturated fatty acid component in the manufacturing process. Also, in this case, the antioxidant may be again added after cooling, if necessary.

In addition, components of the corpuscle combiner manufacturing apparatus may be replaced with any components having the same function, or other components may be added.

In addition, the liquid developer of the invention is not limited to the application to the above-described image forming apparatus.

Although it has been shown and illustrated in the above modes that the corpuscle combiners obtained in the corpuscle combiner manufacturing process are once collected and then provided for the dispersing process, the corpuscle combiners may be directly provided for the dispersing process without being collected. For example, the shown corpuscle combiner manufacturing apparatus 1 may have a dispersing unit that retains the insulating liquid and is supplied with the manufactured corpuscle combiners. That is, the manufactured corpuscle combiners maybe directly dispersed in the insulating liquid that is retained in the collecting unit 5. This makes it possible to more efficiently manufacture the liquid developer and more effectively prevent the corpuscle combiners from being unintentionally conglomerated.

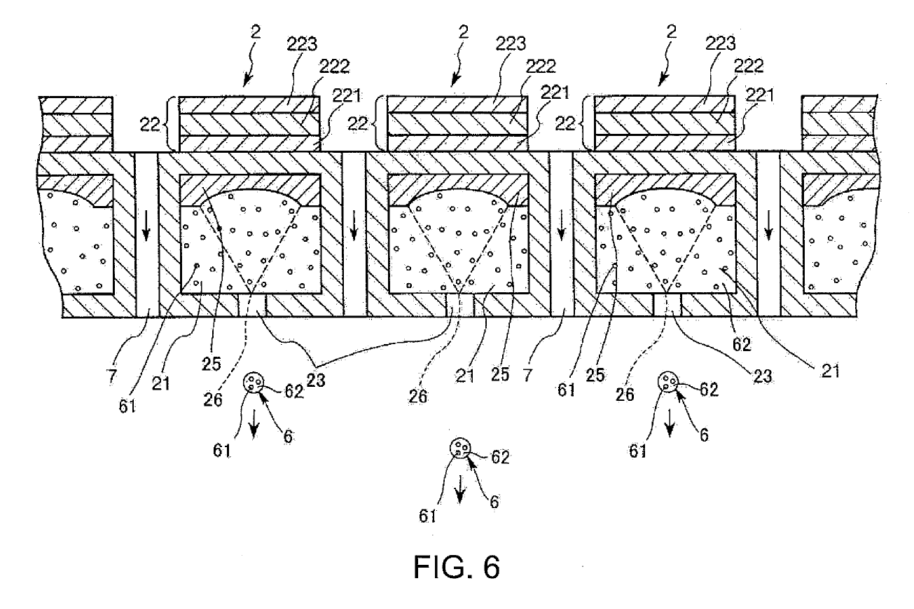

In addition, as shown in FIG. 6, an acoustic lens (concave lens) 25 may be provided in the head unit 2. The provided acoustic lens 25 can converge the pressure pulse (vibration energy) generated by the piezoelectric device 22 into a pressure pulse converging portion 26 near the discharge unit 23. As a result, the vibration energy generated by the piezoelectric device 22 can be efficiently used as energy to discharge the aqueous suspension 6. Accordingly, even when the aqueous suspension 6 that is retained in the dispersion solution retention unit 21 has relatively high viscosity, it is possible to reliably discharge the aqueous suspension 6 from the discharge unit 23. In addition, even when the aqueous suspension 6 that is retained in the dispersion solution retention unit 21 has relatively high cohesive power (surface tension), it is possible to discharge the aqueous suspension 6 as fine liquid drips, thus easily and reliably controlling diameter of the corpuscle combiners 9 to be relatively small.

In this manner, with the shown configuration, even when materials having higher viscosity and cohesive power are used as the aqueous suspension 6, it is possible to control the corpuscle combiners 9 to have a desired shape and size, thereby making it possible to select materials in a wide range to easily obtain toner having desired characteristics.

In addition, with the shown configuration, since the aqueous suspension 6 is discharged by the converged pressure pulse, even when the area (opening area) of the discharge unit 23 is relatively large, it is possible to make size of the discharged aqueous suspension 6 relatively small. That is, if the diameter of the corpuscle combiners 9 is to be relatively small, it is possible to increase the area of the discharge unit 23. This can more effectively prevent clogging in the discharge unit 23 even if the aqueous suspension 6 has relatively high viscosity.

The acoustic lens is not limited to the concave lens, but may include, for example, a fresnel lens, an electron scan lens, etc.

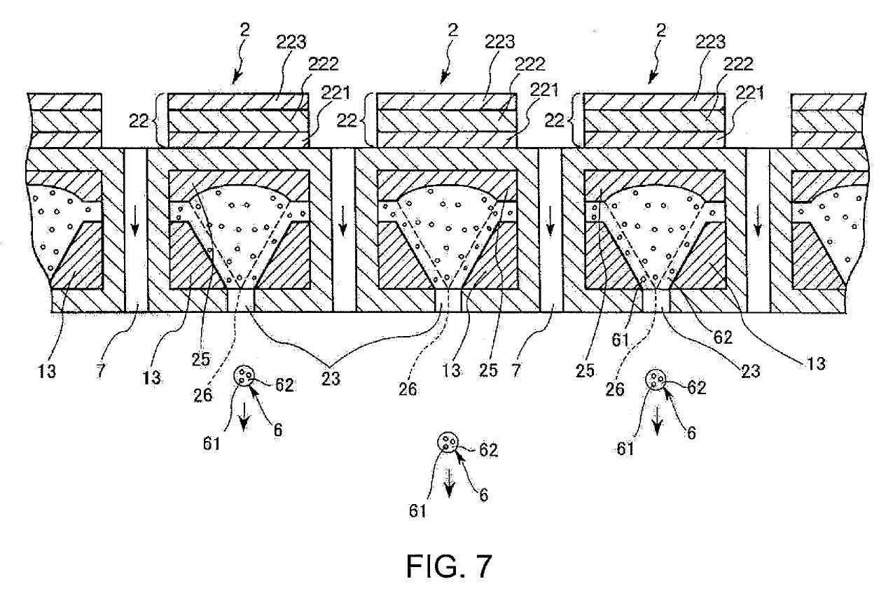

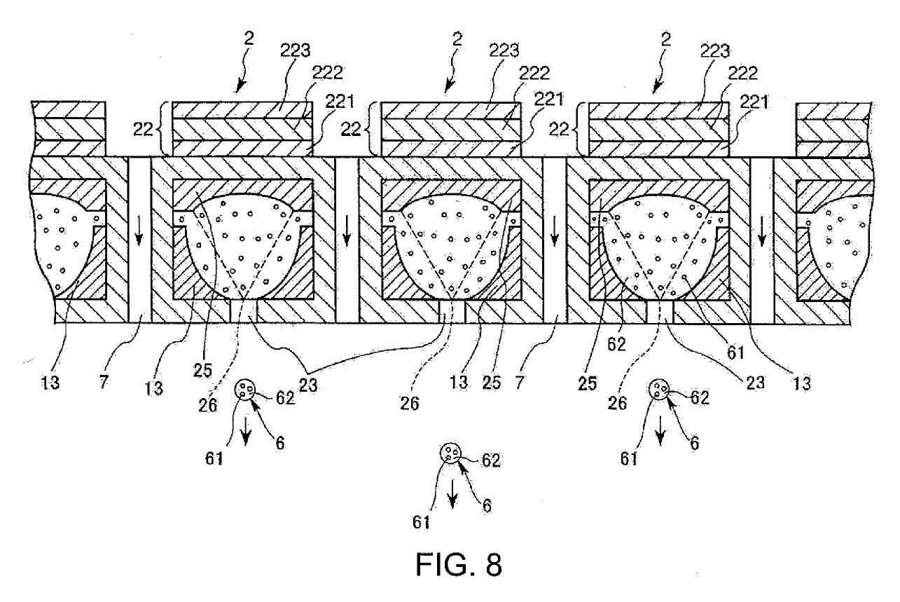

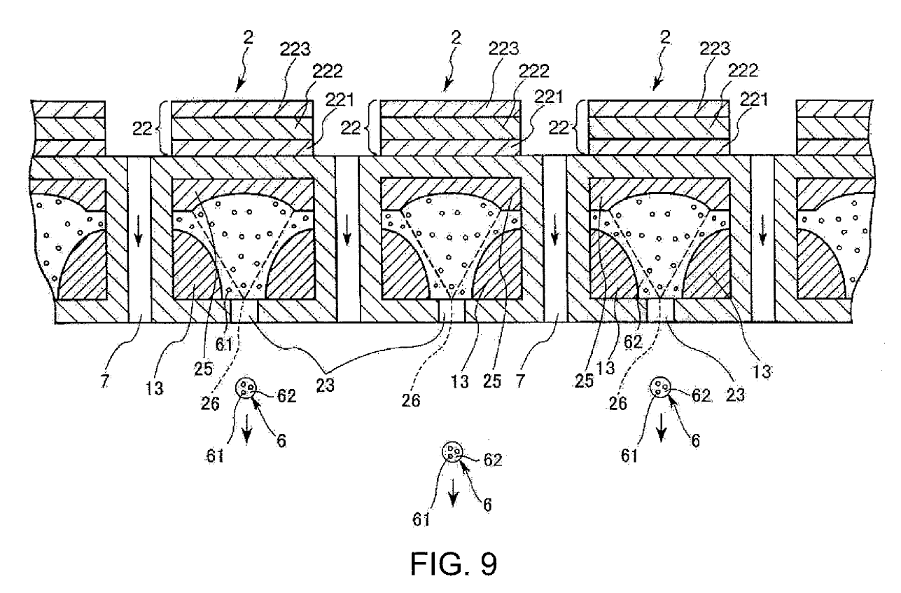

In addition, as shown in FIGS. 7 to 9, a fastening member 13 having a shape that converges into the discharge unit 23 may be interposed between the acoustic lens 25 and the discharge unit 23. The fastening member 13 is used to assist the convergence of the pressure pulse (vibration energy) generated by the piezoelectric device 22, thereby more efficiently using the pressure pulse generated by the piezoelectric device 22.

In addition, although it has been shown in illustrated in the above modes that the components of toner are included as solidified components in the dispersoids, at least a portion of the components of toner may be included in the dispersion medium.

In addition, although it has been shown in illustrated in the above modes that the aqueous suspension (aqueous dispersion solution) is intermittently discharged from the head unit by the piezoelectric pulse, a discharging method (jetting method) of the aqueous suspension (aqueous dispersion solution) is not particularly limited. For example, the discharging method of the aqueous dispersion solution may include a spray dry method, a so-called bubble jet method (“bubble jet” is a registered trade mark), a method of spreading dispersion liquid into a laminar flow by pressing it against a smooth surface using a gas flow, and then jetting the dispersion liquid in the form of fine liquid drops using a nozzle (disclosed in Japanese Patent Application No. 2002-321889), etc. The spray dry method is a method of obtaining liquid drops by using a high pressure gas to jet (spray) liquid (dispersion solution). The so-called bubble jet method (“bubble jet” is a registered trade mark) is disclosed in, for example, Japanese Patent Application No. 2002-169348. That is, “method of intermittently discharging dispersion solution from a head unit according to variation of gas volume” may be applied as the discharging method of the aqueous dispersion solution.

In addition, the corpuscle combiners may not be formed by the discharge of the aqueous suspension (aqueous dispersion solution). For example, the corpuscle combiners may be formed by filtering the aqueous suspension and filtering out and sorting conglomerations of corpuscles corresponding to dispersoids.

In addition, although it has been shown in illustrated in the above modes that the aqueous emulsified solution is prepared using the pulverization of the mixture, the pulverizing process of the mixture may be omitted.

In addition, the method of preparing the aqueous emulsified solution and the aqueous suspension is not limited to the above-described method. For example, by heating dispersion solution in which solidified dispersoids are dispersed, first, the aqueous emulsified solution may be obtained with the dispersoids liquefied, and then, the aqueous suspension may be obtained by cooling the aqueous emulsified solution.

In addition, although it has been shown in illustrated in the above modes that the aqueous suspension is first obtained using the aqueous emulsified solution, and then, the corpuscle combiners are manufactured using the obtained aqueous suspension, the corpuscle combiners may be directly manufactured from the aqueous emulsified solution without via the aqueous suspension. For example, the corpuscle combiners may be obtained by discharging the aqueous emulsified solution as liquid drops and then removing a dispersion medium, along with a solvent in the dispersion medium, from the liquid drops.

In addition, the unsaturated fatty acid glyceride used in the invention may be chemically synthesized (artificially synthesized).

### EXAMPLES

### Example 1

### Preparation of Corpuscle Combiner

First, a polyester resin (softening temperature: 125° C.) of 80 wt % as a combiner resin and a cyan pigment (pigment blue 15:3, available from Dianichiseika Color & Chemical Mfg. Co., Ltd.) of 20 wt % as a coloring agent are prepared.

A raw material used to manufacture toner is obtained by mixing these components using a 20 L type Henschel mixer.

Next, this raw material (mixture) is mixed using a biaxial mixture extruder.

Temperature of the raw material in a processing unit of the biaxial mixture extruder is set to be 105 to 115° C. Time taken for mixture of the raw material is about 4 minutes.

In this condition, the mixture extruded from an extruding port of the biaxial mixture extruder is cooled using a cooler. Temperature of the mixture immediately after the cooling process is about 45° C. Time taken from the end of the mixing process to the end of the cooling process is about 10 seconds.

The cooled mixture is coarsely pulverized to obtain powders having an average diameter of 1.5 mm. A hammer mill is used for the coarse pulverization of the mixture.

Next, the mixture coarse pulverization of 100 wt % is added to toluene of 250 wt %, and is treated for one hour using an ultrasonic homogenizer (output current: 400 μA) to obtain a solution in which a polyester resin of the mixture is dissolved. A pigment is uniformly microscopically dispersed inn this solution.

In the mean time, an aqueous liquid in which a dodecylbenzenesulfonesodium of 1 wt % as a dispersing agent is uniformly mixed with an ion exchange water of 700 wt % is prepared.

The number of rotations of agitation of the aqueous liquid is adjusted using a homo mixer (available from Tokushu Kika Kogyo Co., Ltd.).

The solution (toluene solution of the mixture) is dropped in the agitated aqueous liquid. Accordingly, an aqueous emulsified solution in which dispersoids having an average diameter of 0.3 μm are uniformly dispersed is obtained. An average diameter of particles in examples and comparative examples refers to a volume-based average diameter, and the average diameter and a granularity distribution of particles are measured using a Mastersizer 2000 particle analysis apparatus (available from Malvern Instruments Ltd.).

Thereafter, under conditions of temperature of 100° C. and atmosphere pressure of 80 kPa, toluene is removed from the aqueous emulsified. Thereafter, at a room temperature, by adding the predetermined amount of water to adjust concentration, an aqueous suspension in which solidified corpuscles are dispersed is obtained. Toluene does not substantially remain in the obtained aqueous suspension. The concentration of solidification (dispersoids) of the obtained aqueous suspension is 28.8 wt %. By adding ion exchange water to the aqueous suspension, the concentration of solidification is adjusted to 4.8 wt %. An average diameter of the dispersoids (solidified corpuscles) dispersed in the suspension is 0.2 μm.

The obtained suspension is put in the aqueous suspension supply unit of the corpuscle combiner manufacturing apparatus shown in FIGS. 1 and 2. The aqueous suspension in the aqueous suspension supply unit is supplied to the head unit by a metering pump while being agitated by an agitating unit, and is discharged (jetted) from the discharge unit to the dispersion medium removing unit. The discharge unit has a circular shape having a diameter of 25 μm. The neighborhood of the discharge unit of the head unit is subject to a hydrophobic treatment by fluorine resin (polytetrafluoroethylene) coating. In addition, temperature of the aqueous suspension in the aqueous suspension supply unit is adjusted to be 25° C.

The aqueous suspension is discharged under conditions wherein the temperature of the aqueous suspension in the head unit is 25° C., the frequency of the piezoelectric film is 10 kHz, the first speed of the aqueous suspension discharged from the discharge unit is 3 m/second, and the discharge amount of one drop of the aqueous suspension discharged from the head unit is 4.2 pl (diameter: 22. 6 μm). In addition, the aqueous suspension is discharged from at least two adjacent head units have different discharge timings.

In addition, at the time of discharging the aqueous suspension, air is downward jetted from the gas nozzle under conditions of temperature of 25° C., humidity of 27% RH and flow rate of 3 m/second. In addition, the internal temperature (atmosphere temperature) of the housing is set to be 45° C. The internal pressure of the housing is about 1.5 kPa. The length of the dispersion medium removing unit (in a carrying direction) is 1.0 m.

In addition, a voltage is applied to the housing of the dispersion medium removing unit such that a potential at its inner surface becomes −200 V in order to prevent the aqueous suspension (corpuscle combiners) from being adhered to its inner wall.

In the dispersion medium removing unit, the dispersion medium is removed from the discharged aqueous suspension to form corpuscle combiners (toner particles) having different shapes and sizes corresponding to dispersoids.

The corpuscle combiners formed in the dispersion medium removing unit are collected in a cyclone to obtain the corpuscle combiners. An average diameter of the corpuscle combiners is 1.48 μm. In addition, an enlarged image for some of the corpuscle combiners is obtained using an electron scan microscope JSM-7500F (available from JEOL Datum Ltd.). An average diameter measured for 100 corpuscles of the corpuscle combiners is 0.2 μm.

### Preparation of Liquid Composing Insulating Liquid

As the insulating liquid, liquid including unsaturated fatty acid glyceride as a main component and liquid including unsaturated fatty acid methylester as a main component are prepared as follows.

First, roughly large soybean oil is refined to obtain refined soybean oil as follows.

First, the roughly large soybean oil is roughly refined by a low temperature crystallization method using methanol, diethylether, petroleum ether, acetone or the like as a solvent.

Next, the roughly refined soybean oil (first roughly refined oil) of 300 volume % isinput in aflask, andthen, boiled water of 100 volume % is put in the flask and the flask is closed up.

Next, the flask is shaken to mix the roughly refined soybean oil (first roughly refined oil) with the boiled water.

Next, the mixture in the flask is left alone until the mixture is separated into three layers.

After the complete separation is confirmed, the flask is left alone in a freezer for 24 hours.

Thereafter, components not frozen are moved to another flask.

The above operations are repeated for the components not frozen, and then, the obtained components not frozen are drawn out to obtain roughly refined oil (second roughly refined oil).

Next, the obtained roughly refined oil (second roughly refined oil) of 100 volume % and activated white clay of 35 volume % including aluminum silicate as a main component are mixed and agitated in a flask.

Next, mixture obtained is preserved for 48 hours under a pressure of 0.18 MPa.

Thereafter, precipitates are removed to obtain refined soybean oil (hereinafter abbreviated as soybean oil). The soybean oil includes fatty acid glyceride having linoleic acid as a main component, and the content ratio of unsaturated fatty acid glyceride in the soybean is 98 wt %. Linoleic acid component is 53 mol % of total fatty acid component.

Next, some of the soybean oil is transesterificated with methanol, and glyceride produced by this transesterification is removed to obtain liquid including fatty acid monoester as a main component. By refining this liquid, soybean fatty acid methylester having the content ratio of more than 99.9 wt % of fatty acid monoester is obtained. The obtained fatty acid methylester mainly includes unsaturated fatty acid monoester such as oleic acid methyl, linoleic acid methyl, α-linoleic acid methyl and the like, and saturated fatty acid monoester such as palmitic methyl stearic methyl and the like.

### Preparation of Liquid Developer

Polyamine aliphatic polycondensation reactions (Solsperse 11200 (trade mark) available from Lubrizol Japan Limited.) of 1 wt % and static acid aluminum (available from NOF Corporation.) of 0.5 wt % are added to a mixture of the above-obtained soybean oil fatty acid methylester of 60 wt % and soybean oil of 100 wt %. In addition, during agitation, the above-obtained corpuscle combiners of 40 wt % are added and dispersed to obtain the insulating liquid.

### Example 2

Rough rapeseed oil is refined with the same operation as the soybean of Example 1 to obtain refined rapeseed oil (hereinafter abbreviated as rapeseed oil). The rapeseed oil includes fatty acid glyceride having an oleic acid as a main component, and the content ratio of unsaturated fatty acid glyceride in the rapeseed oil is 98 wt %. Oleic acid component and linoleic acid component are 52 mol % and 24 mol % of total fatty acid, respectively.

Next, some of the rapeseed oil is transesterificated with methanol, and glyceride produced by this transesterification is removed to obtain liquid including fatty acid monoester as a main component. By refining this liquid, rapeseed oil fatty acid methylester having the content ratio of more than 99.9 wt % of fatty acid monoester is obtained.

Hereinafter, the liquid developer is manufactured in the same manner as Example 1, except that, as the insulating liquid, rapeseed oil fatty acid methylester of 60 wt % is used instead of the soybean oil fatty acid methylester, and rapeseed oil of 100 wt % is used instead of the soybean oil.

### Example 3

Rough linseed oil is refined with the same operation as the soybean of Example 1 to obtain refined linseed oil (hereinafter abbreviated as linseed oil). The linseed oil includes fatty acid glyceride having an α-linoleic acid as a main component, and the content ratio of unsaturated fatty acid glyceride in the linseed oil is 98 wt %. α-linoleic acid component and linoleic acid component are 18 mol % and 15 mol % of total fatty acid, respectively.

Next, some of the linseed oil is transesterificated with methanol, and glyceride produced by this transesterification is removed to obtain liquid including fatty acid monoester as a main component. By refining this liquid, linseed oil fatty acid methylester having the content ratio of more than 99.9 wt % of fatty acid monoester is obtained.

Hereinafter, the liquid developer is manufactured in the same manner as Example 1, except that, as the insulating liquid, linseed oil fatty acid methylester of 60 wt % is used instead of the soybean oil fatty acid methylester, and linseed oil of 80 wt % and rapeseed oil of 20 wt % are used instead of the soybean oil.

### Example 4

Rough olive oil is refined with the same operation as the soybean of Example 1 to obtain refined olive oil (hereinafter abbreviated as olive oil). The olive oil includes fatty acid glyceride having an oleic acid as a main component, and the content ratio of unsaturated fatty acid glyceride in the olive oil is 99 wt %. Oleic acid component and linoleic acid component are 73 mol % and 11 mol % of total fatty acid, respectively.

Next, some of the olive oil is transesterificated with methanol, and glyceride produced by this transesterification is removed to obtain liquid including fatty acid monoester as a main component. By refining this liquid, olive oil fatty acid methylester having the content ratio of more than 99.9 wt % of fatty acid monoester is obtained.

Hereinafter, the liquid developer is manufactured in the same manner as Example 1, except that, as the insulating liquid, olive oil fatty acid methylester of 60 wt o is used instead of the soybean oil fatty acid methylester, and olive oil of 100 wt % is used instead of the soybean oil.

### Example 5

The liquid developer is manufactured in the same manner as Example 1, except that soybean oil fatty acid methylester of 23 wt % and soybean oil of 137 wt % are used as the insulating liquid.

### Example 6

The liquid developer is manufactured in the same manner as Example 1, except that soybean oil fatty acid methylester of 120 wt % and soybean oil of 40 wt % are used as the insulating liquid.

### Example 7

The corpuscle combiners and insulating liquid are manufactured in the same manner as Example 1, except that the discharge amount of one drop of the aqueous suspension discharged from a head unit having a large opening diameter of the discharge unit is 9.0 pl (diameter of liquid drops: 32. 8 μm) in the aqueous suspension discharging process.

### Example 8

The corpuscle combiners and insulating liquid are manufactured in the same manner as Example 1, except that the discharge amount of one drop of the aqueous suspension discharged from a head unit having a small opening diameter of the discharge unit is 1.8 pl (diameter of liquid drops: 9. 2 μm) in the aqueous suspension discharging process.

### Example 9

In adjusting the aqueous emulsified solution in Embodiment 1, by adjusting the number of rotations of agitation of the homo mixer and dropping a toluene solution of the mixture, an aqueous emulsified solution in which dispersoids having an average diameter of 1.8 μm are uniformly dispersed is obtained.

Hereinafter, the liquid developer is manufactured in the same manner as Example 1. An average diameter of corpuscles of the corpuscle combiners existing in the obtained liquid developer is 1.6 μm.

### Example 10

In adjusting the aqueous emulsified solution in Example 1, by adjusting the number of rotations of agitation of the homo mixer and dropping a toluene solution of the mixture, an aqueous emulsified solution in which dispersoids having an average diameter of 0.08 μm are uniformly dispersed is obtained.

Hereinafter, the liquid developer is manufactured in the same manner as Example 1. An average diameter of corpuscles of the corpuscle combiners existing in the obtained liquid developer is 0.05 μm.

### Example 11

In the aqueous suspension discharging process, an aqueous suspension having the concentration of solidification of 28.8 wt % before dilution by ion exchange water is used. The corpuscle combiners are manufactured in the same manner as Example 1, except that the discharge amount of one drop of the aqueous suspension discharged from the head unit is 4 pl (diameter of liquid drops: 20.8 μm). An average diameter of the obtained corpuscle combiners is 8.5 μm.

The obtained corpuscle combiners of 40 wt %, soybean oil fatty acid methylester of 60 wt %, soybean oil of 100 wt %, polyamine aliphatic polycondensation reactions (Solsperse 11200 (trade mark) available from Lubrizol Japan Limited.) of 1 wt % and static acid aluminum (available from NOF Corporation.) of 0.5 wt % are put in a ceramic pot (volume: 600 ml), and then, zirconium oxide balls (diameter: 3 mm) are put in the ceramic pot to have a volume fill ratio of 30%. After deagglormeration is performed for 200 hours at a rotation speed of 220 rpm with a desk pot mill, dispersion solution is separated from the zirconium oxide balls to obtain the liquid developer.

### Example 12

### Preparation of Polyester Resin (Emulsified Polymerization)

1,9-nonandiol, 1,10-dodecanedioicacid, styrene monomer, butylacrylate monomer, hexadecane and dpdecanediol are mixed in a three-hole flask at 80° C. and then cooled at a room temperature, and then, a scandiumtrifluoromethanesulfonate [Sc(OSO₂CF₃)₃] is added as a catalyst and is dissolved.

This mixture is put in ion exchange water in which dodecylbenzenesulfonenatrium and trisdodecylscandicsulfate are dissolved, preliminarily dispersed using an ultrasonic wave, and emulsified at 80° C. using an extra high pressure homogenizer (Nano-Mizer available from Yoshida Kikai Co., Ltd.) to obtain an emulsion.

The emulsion is put in a 3 L pressure reactor having an agitator and is polymerized at 100° C. for 12 hours under a nitrogen atmosphere. Corpuscles in a reacting solution remain in a stable emulsion state, and their average diameter is 0.3 μm.

Acryl acid is added to the obtained reacting solution and is left alone while agitating them at 80° C. for one hour. After sufficiently distributing the acryl acid in resin corpulscles, an ammonium persulfate aqueous solution is added, and polymerization is conducted at 80° C. for 5 hours under a nitrogen atmosphere to obtain a stable resin corpuscle dispersion solution having corpuscles having an average diameter of 0.3 μm. After cleaning and drying Some of the resin corpuscle dispersion solution, its softening temperature is measured to 105° C.

### Adjustment of Pigment Dispersion Solution

Cyan pigment (pigment blue 15:3, available from Dianichiseika Color & Chemical Mfg. Co., Ltd.), anion surfactant (NEOGEN R available from DAI-ICHI Kogyo Seiyaku Co. Ltd.), and ion exchange water are mixed and dissolved, and dispersed for about one hour using a high pressure impact disperser ultimaizer (HJP30006 available from Sugino Machine Limited.) to prepare a cyan pigment. An average diameter of the dispersed pigment is 0.15 μm, and concentration of coloring agent particles is 23 wt %.

### Preparation of Toner Particle

The resin corpuscle dispersion solution obtained by polymerizing the above radical polymerized monomer, the pigment dispersion solution and ion exchange water are put in a 2 L cylindrical stainless steel container and are mixed and dispersed for 15 minutes while applying a shear force at 8000 rpm by Ultraturrax. Subsequently, a 10% nitric acid aqueous solution of polyaluminum chloride as a cohesive agent is dropped.

Thereafter, while agitating a raw material dispersion solution in an agitator and a stainless steel polymerization oven having a thermometer, resin particles and pigment particles are slowly heated and conglomerated, and their average diameters are measured to 6.4 μm. Thereafter, after increasing pH to 9.0, increasing temperature to 95° C., and maintaining the particles for 20 minutes, corpuscle combiners having an average particle diameter of 6.0 μm is obtained. Thereafter, the corpuscle combiners are sufficiently and repeatedly cleaned and dried with a freeze dryer.

Hereinafter, the liquid developer is obtained by deagglomerating the corpuscle combiners in the insulating liquid in the same manner as Example 11 except that deagglomeration time is 160 hours.

### Comparative Example 1

The liquid developer is manufactured in the same manner as Example 1, except that liquid paraffin of 160 wt % is used as the insulating liquid, instead of the soybean oil fatty acid methylester and the soybean oil.

### Comparative Example 2

A polyester resin (softening temperature: 125° C.) of 80 wt % as a binder resin and a cyan pigment (pigment blue 15: 3, available from Dianichiseika Color & Chemical Mfg. Co., Ltd.) of 20 wt % as a coloring agent are mixed at 130° C. exceeding the softening temperature of the resin and roughly pulverized with 1 to 10 mm angles using two rolls to obtain coloring chips.

Next, the coloring chips are pulverized with a fin mill while cooling the chips with liquefied nitrogen, and classified with a mesh having openings having a diameter of 150 μm to obtain pulverizations having an average diameter of 42 μm.

Next, the pulverizations of 40 wt % are mixed with ion exchange water of 160 wt % and are wet-pulverized with an atoritor (available from Union Process Co., Ltd.). An average diameter of particles in water is 2.0 μm.

Next, the obtained pulverizations of 100 wt % are slowly dropped into the insulating liquid of 50 wt % while irradiating them using an ultrasonic homogenizer to obtain a mixture. In addition, a mixture of a liquid paraffin having low viscosity and a surfactant (1,2-hydroxy stearic acid methyl) of 2 wt % is used as the insulating liquid.

Next, a liquid developer is obtained by removing water from the obtained mixture using a vaporizer. The water is removed under conditions of treatment temperature of 70° C. and treatment pressure of 10 kPa.

For the above examples and comparative examples, Table 1 shows manufacture conditions and physical properties of the liquid developer. In addition, in Table 1, oleic acid in a kind item of unsaturated fatty acid is represented by OL, linoleic acid being represented by LN, and α-linoleic acid being represented by LL. In addition, width S of a granularity distribution of toner particles which is expressed by the following equation (I) is shown in Table 1,

S=[D(90)−D(10)]/D(50) (I)

where D(X) represents a diameter at a point of X % of total volume as accumulated volume when a granularity distribution of toner particles is measured starting from toner particles having smaller diameter.

TABLE 1

| | | | | | | Insulating |
|---|---|---|---|---|---|---|
| | | | | | | liquid |
| | | | | | | Unsaturated |
| | Toner particle | | | | | fatty acid |
| | Resin material | | Average | Average | | glyceride |
| | | Softening | diameter of | diameter of | | Kind of |
| | | Temperature | toner particle | corpuscle | Granularity | unsaturated |
| | Kind | [° C.] | [μm] | [μm] | distribution S | fatty acid |
| Example 1 | Polyester resin | 125 | 1.48 | 0.20 | 1.19 | LN, OL, LL |
| Example 2 | Polyester resin | 125 | 1.48 | 0.20 | 1.19 | OL, LN, LL |
| Example 3 | Polyester resin | 125 | 1.48 | 0.20 | 1.19 | LL, LN, OL |
| Example 4 | Polyester resin | 125 | 1.48 | 0.20 | 1.19 | OL, LN, LL |
| Example 5 | Polyester resin | 125 | 1.48 | 0.20 | 1.19 | LN, OL, LL |
| Example 6 | Polyester resin | 125 | 1.48 | 0.20 | 1.19 | LN, OL, LL |
| Example 7 | Polyester resin | 125 | 3.30 | 0.20 | 1.08 | LN, OL, LL |
| Example 8 | Polyester resin | 125 | 0.64 | 0.20 | 1.31 | LN, OL, LL |
| Example 9 | Polyester resin | 125 | 2.56 | 1.6 | 1.38 | LN, OL, LL |
| Example 10 | Polyester resin | 125 | 1.34 | 0.05 | 1.02 | LN, OL, LL |
| Example 11 | Polyester resin | 125 | 1.23 | 0.20 | 1.28 | LN, OL, LL |
| Example 12 | Polyester resin | 105 | 1.68 | 0.30 | 1.40 | LN, OL, LL |
| Comparative | Polyester resin | 125 | 1.48 | 0.20 | 1.19 | — |
| Example 1 | | | | | | |
| Comparative | Polyester resin | 125 | 2.10 | — | 3.21 | LN, OL, LL |
| Example 2 | | | | | | |

| | Insulating liquid | | | | | |
|---|---|---|---|---|---|---|
| | Unsaturated fatty acid glyceride | | | | | |
| | Linoleic acid | Content of | Mono fatty acid ester | | | |
| | component of | unsaturated fatty | | Content of fatty | | |
| | fatty acid | acid glyceride in | Kind of | acid monoester | | |
| | component | insulating liquid | unsaturated | in insulating | Viscosity | |
| | [mol %] | [Wt %] | fatty acid | liquid [Wt %] | [mPa · S] | Iodine value |
| Example 1 | 53 | 61 | LN, OL, LL | 37 | 200 | 135 |
| Example 2 | 24 | 61 | OL, LN, LL | 37 | 110 | 160 |
| Example 3 | 15 | 61 | LL, LN, OL | 37 | 180 | 201 |
| Example 4 | 11 | 61 | OL, LN, LL | 37 | 140 | 86 |
| Example 5 | 53 | 83 | LN, OL, LL | 14 | 320 | 130 |
| Example 6 | 53 | 15 | LN, OL, LL | 85 | 50 | 53 |
| Example 7 | 53 | 61 | LN, OL, LL | 37 | 160 | 135 |
| Example 8 | 53 | 61 | LN, OL, LL | 37 | 350 | 135 |
| Example 9 | 53 | 61 | LN, OL, LL | 37 | 150 | 135 |
| Example 10 | 53 | 61 | LN, OL, LL | 37 | 200 | 135 |
| Example 11 | 53 | 61 | LN, OL, LL | 37 | 130 | 135 |
| Example 12 | 53 | 61 | LN, OL, LL | 37 | 260 | 135 |
| Comparative | — | — | — | — | 550 | — |
| Example 1 | | | | | | |
| Comparative | 53 | 61 | LN, OL, LL | 37 | 250 | 135 |
| Example 2 | | | | | | |

### [2] Evaluation

Fixation strength, transfer efficiency, development efficiency and resolution for a toner image formed using the liquid developers obtained as above are evaluated.

### [2.1] Fixation Strength

The fixing unit is detached from the image forming apparatus shown in FIG. 3, and images having predetermined patterns by the liquid developers obtained in the above examples and comparative examples are formed on recording sheets (woodfree paper, LPCPPA4 available from Seiko Epson Corporation). Thereafter, the images formed on the recording sheets are thermally fixed using an oven. The thermal fixation is performed under conditions of 110° C.×40 minutes.

Thereafter, after confirming a non-offset region, the images fixed on the recording sheets are twice rubbed with pressing load of 0.8 kgf using an eraser (sand eraser “LION 261-11” available from LION Office Products Corp.), and retention rates of concentration of the images are measured using “X-Rite model 404” (available from X-Rite Inc.) and are evaluated according to the following 5-step criterion:

[symbol] more than 95% in image concentration retention rate

[symbol] more than 90% and less than 95% in image concentration retention rate

◯: more than 80% and less than 90% in image concentration retention rate

Δ: more than 70% and less than 80% in image concentration retention rate

×: less than 70% in image concentration retention rate.

### [2.2] Transfer Efficiency

The second transfer roller P19 and the fixing unit shown in FIG. 5 are detached from the image forming apparatus shown in FIG. 3, and images are formed on the intermediate transfer roller P18. Toner remaining on the photoconductor P2 and toner adhered to the intermediate transfer roller P18 are gathered using mending tapes. Concentration of toner images on the mending tapes is measured using “X-Rite model 404” (available from X-Rite Inc.), and transfer efficiencies are obtained from the following equation and are evaluated according to the following 4-step criterion:

Transfer Efficiency (%)=B/(A+B)×100

(A: concentration of toner image on mending tape gathering the remaining toner on the photoconductor P2, B: concentration of toner image on mending tape gathering the toner on the intermediate transfer roller P18)

[symbol] more than 95% in transfer efficiency

◯: more than 80% and less than 95% in transfer efficiency

Δ: more than 65% and less than 80% in transfer efficiency

×: less than 65% in transfer efficiency.

### [2.3] Development Efficiency

The intermediate transfer roller P18, the second transfer roller P19 and the fixing unit shown in FIG. 5 are detached from the image forming apparatus shown in FIG. 3, and development is performed for the photoconductor P2. Toner remaining on the photoconductor P2 and toner adhered to the developing roller P13 are gathered using mending tapes. Concentration of toner images on the mending tapes is measured using “X-Rite model 404” (available from X-Rite Inc.), and development efficiencies are obtained from the following equation and are evaluated according to the following 4-step criterion:

Development Efficiency (%)=D/(C+D)×100

(C: concentration of toner image on mending tape gathering the remaining toner on the developing roller P13, D: concentration of toner image on mending tape gathering the toner on the photoconductor P2)

[symbol] more than 95% in development efficiency

[symbol] more than 85% and less than 95% in development efficiency

◯: more than 75% and less than 85% in development efficiency

Δ: more than 65% and less than 75% in development efficiency

×: less than 65% in development efficiency.

### [2.4] Resolution

Using the image forming apparatus shown in FIG. 3, images having predetermined patterns by the liquid developers obtained in the above examples and comparative examples are formed on recording sheets, and resolutions for the images are examined by naked eyes.

### [2.5] Glossiness

Using the image forming apparatus shown in FIG. 3, images having predetermined patterns by the liquid developers obtained in the above examples and comparative examples are formed on recording sheets, and mirror gloss nesses for the images are measured according to a measurement method of JIS standard (JIS Z 8741-1997) and are evaluated according to the following 4-step criterion:

[symbol] more than 60% in glossiness

[symbol] more than 50% and less than 60% in glossiness

◯: more than 40% and less than 50% in glossiness

Δ: more than 30% and less than 40% in glossiness

×: less than 30% in glossiness.

### [2.6] Preservation

The liquid developers obtained in the above examples and comparative examples are left alone for 8 months under a condition of temperature of 15 to 25° C. Thereafter, states of toners in the liquid developers are observed by naked eyes and are evaluated according to the following 5-step criterion:

[symbol] No floating, conglomeration and precipitation of toner particle,

[symbol] little floating, conglomeration and precipitation of toner particle,

◯: some floating, conglomeration and precipitation of toner particle, but acceptable as liquid developer

Δ: much floating, conglomeration and precipitation of toner particle,

×: remarkable floating, conglomeration and precipitation of toner particle.

### [2.7] High Speed Print Aptitude

Using the liquid developers obtained in the above examples and comparative examples, the fixation temperature of the image forming apparatus is set to be 160° C., nip time of the fixing roll is set to be 0.08 second, and images are formed without ultraviolet rat irradiation by the ultraviolet ray irradiation unit F8. Badness of image quality, such as spots, blurring and so on, of the formed images is evaluated according to the following 4-step criterion (condition 1):

[symbol] No badness of image quality, such as spots, blurring and so on,

◯: some badness of image quality, such as spots, blurring and so on,

Δ: much badness of image quality, such as spots, blurring and so on,

×: remarkable badness of image quality, such as spots, blurring and so on.

Using the liquid developers obtained in the above examples and comparative examples, the fixation temperature of the image forming apparatus is set to be 140° C., nip time of the fixing roll is set to be 0.05 second, and images are formed with ultraviolet rat irradiation by the ultraviolet ray irradiation unit F8. Likewise, badness of image quality of the formed images is evaluated (condition 2).

The result of evaluation is listed in Table 2.

TABLE 2

| | Transfer | Development | Resolution | | | High speed print aptitude | |
|---|---|---|---|---|---|---|---|
| Fixation strength | efficiency | efficiency | [number/min] | Glossiness | Preservation | Condition 1 | Condition 2 |

| | | | | | | | | |
|---|---|---|---|---|---|---|---|---|
| Example 1 | [symbol] [symbol] | [symbol] | [symbol] [symbol] | 9.2 | [symbol] [symbol] | [symbol] [symbol] | [symbol] | [symbol] |
| Example 2 | [symbol] [symbol] | [symbol] | [symbol] | 9.3 | [symbol] | [symbol] | [symbol] | [symbol] |
| Example 3 | [symbol] [symbol] | ◯ | [symbol] | 9.0 | [symbol] | [symbol] | [symbol] | ◯ |
| Example 4 | ◯ | [symbol] | [symbol] | 7.0 | [symbol] | ◯ | ◯ | ◯ |
| Example 5 | [symbol] | [symbol] | [symbol] [symbol] | 8.9 | [symbol] | [symbol] | [symbol] | ◯ |
| Example 6 | [symbol] | [symbol] | [symbol] | 8.5 | [symbol] | ◯ | ◯ | ◯ |
| Example 7 | ◯ | ◯ | [symbol] | 6.0 | ◯ | ◯ | ◯ | ◯ |
| Example 8 | ◯ | ◯ | [symbol] | 8.9 | [symbol] | ◯ | [symbol] | ◯ |
| Example 9 | ◯ | ◯ | [symbol] | 6.7 | ◯ | [symbol] | [symbol] | ◯ |
| Example 10 | ◯ | ◯ | ◯ | 8.8 | [symbol] | ◯ | [symbol] | [symbol] |
| Example 11 | [symbol] [symbol] | [symbol] | [symbol] | 9.0 | [symbol] | [symbol] [symbol] | [symbol] | [symbol] |
| Example 12 | ◯ | ◯ | ◯ | 7.0 | [symbol] | ◯ | [symbol] | [symbol] |
| Comparative | X | ◯ | ◯ | 6.4 | X | X | ◯ | X |
| Example 1 | | | | | | | | |
| Comparative | ◯ | X | X | 4.8 | X | X | Δ | Δ |
| Example 2 | | | | | | | | |

As apparent from Table 2, the liquid developers of the invention are excellent in transfer efficiency and development efficiency of toner images, resolution, glossiness and fixation strength of formed images, and preservation of liquid developers. On the contrary, the liquid developers in the comparative examples do not show satisfied results.

In addition, in the examples, good image quality can be obtained with the ultraviolet ray irradiation by means of the ultraviolet ray irradiation unit even in fixation at a low temperature for a short time, however, good image quality is not obtained in the comparative examples.

In addition, the liquid developers are manufactured and evaluated in the same manner as the above, except that pigment red 122, pigment yellow 180 and carbon black (Printex L available from Degussa Ltd.) are used as coloring agents instead of the cyan pigment, however, the results as described above are not obtained.

What is claimed is:

1. A liquid developer comprising an insulating liquid and toner particles dispersed in the insulating liquid,
wherein the toner particles include a plurality of corpuscle combiners including a resin material, and
wherein the insulating liquid includes glyceride of an unsaturated fatty acid.

2. The liquid developer according to claim 1, wherein viscosity of the insulating liquid is 5 to 1000 mPa·s.

3. The liquid developer according to claim 1, wherein an iodine value of the insulating liquid is 100 to 200.

4. The liquid developer according to claim 1, wherein the content ratio of linoleic acid to total fatty acid components constituting the glyceride is more than 15 mol %.

5. The liquid developer according to claim 1, wherein an average diameter of the toner particles is 0.7 to 3 μm.

6. The liquid developer according to claim 1, wherein an average diameter of corpuscles constituting the toner particles is 0.03 to 1.5 μm.

7. A method of manufacturing a liquid developer including an insulating liquid and toner particles dispersed in the insulating liquid, the method comprising:
combining a plurality of corpuscles including a resin material as a main component to obtain corpuscle combiners; and
dispersing the corpuscle combiners in a liquid including glyceride of an unsaturated fatty acid.

8. The method according to claim 7, wherein the corpuscle combiners are manufactured by:
pulverizing a dispersion solution in which dispersoids including the resin material are microscopically dispersed, and discharging the pulverized dispersion solution from a head unit; and
removing a dispersion medium from the dispersion solution and obtaining the corpuscle combiners in which the plurality of corpuscles derived from the dispersoids are combined.

9. The method according to claim 7, wherein the corpuscle combiners are manufactured by:
mixing a resin dispersion solution in which a resin material prepared by emulsified polymerization is microscopically dispersed and a coloring agent dispersion solution in which a coloring agent is microscopically dispersed; and
conglomerating dispersoids in the resin dispersion solution and dispersoids in the coloring agent dispersion solution.

10. An image forming method for fixing toner particles onto a recording medium to which the toner particles are adhered while heating and pressurizing the recording medium, wherein the image forming method uses the liquid developer according to claim 1.

11. The image forming method according to claim 10, wherein a toner image is irradiated with an ultraviolet ray when the toner particles are fixed onto the recording medium.

12. An image forming apparatus for fixing toner particles onto a recording medium to which the toner particles are adhered while heating and pressurizing the recording medium, wherein the image forming apparatus uses the liquid developer according to claim 1.

13. The image forming apparatus according to claim 12, wherein the image forming apparatus includes an ultraviolet ray irradiation unit that irradiates a toner image with an ultraviolet ray when the toner particles are fixed onto the recording medium.
